(19) United States
(12) Patent Application Publication
(10) Pub. No.: US 2009/0327735 A1
(43) Pub. Date: Dec. 31, 2009

(54) UNIDIRECTIONAL MULTI-USE PROXY RE-SIGNATURE PROCESS

(75) Inventors: Min Feng, Beijing (CN); Bin Benjamin Zhu, Edina, MN (US); Jun Shao, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,480

(22) Filed: Jun. 26, 2008

(51) Int. Cl. H04L 9/06

(52) U.S. Cl. 713/180

(57) ABSTRACT

A “proxy re-signature system” provides various techniques for transforming a delegatee's signature on a message m into a delegator's on the same message m. Various embodiments of non-interactive re-signature generation processes are described. Various embodiments to aggregate part of signatures to reduce the size of re-signed signatures are also described. Various combinations of the proxy re-signature process and the re-signature conversion process result in an overall process that is unidirectional, multi-use, private, and non-interactive. As such, the proxy re-signature system is applicable for use with a wide range of applications.

### BACKGROUND

1. Technical Field

A “proxy re-signature system” provides a mechanism that allows secure proxy re-signatures, and in particular, various techniques for enabling secure, multi-use, unidirectional, and private proxy re-signatures in combination with various techniques for converting any secure proxy re-signature into one that is collusion-resistant with flexible temporary delegations without the need to involve a trusted third party.

2. Related Art

Conventionally, “proxy re-signature” techniques, as are well known to those skilled in the art, involve a cryptography technique in which a semi-trusted proxy acts as a translator between a delegatee (typically referred to as “Alice” or simply as “A”) and a delegator (typically referred to as “Bob” or simply as “B”). Such techniques are used to convert a signature (i.e., a “signing key”) from A into a signature from B on the same message.

However, for purposes of security, conventional proxy re-signature techniques ensure that the proxy does not actually learn the signing key of either Alice or Bob during the re-signature process, and cannot sign arbitrary messages on behalf of either Alice or Bob. In other words, in a conventional proxy re-signature scheme, a semi-trusted proxy is given some information which allows it to transform Alice's signature on a message m into Bob's signature on m, but the proxy cannot, on its own, generate signatures for either Alice or Bob. Note that in some unsecure signature schemes, an adversary may fake a signature by using the signatures he/she already has without knowing the signing key.

There are a number of properties that have been identified as desirable for use in various types of conventional proxy re-signature schemes. For example, these properties include the following:
1. Directionality: In a unidirectional scheme, a re-signature key allows the proxy to transform A's signature to B's but not vice versa. Conversely, in a bidirectional scheme, on the other hand, the re-signature key allows the proxy to transform A's signature to B's as well as B's signature to A's.
2. Uses: In a multi-use scheme, a transformed signature can be re-transformed again. Conversely, in a single-use scheme, the proxy can transform only signatures that have not already been transformed.
3. Private vs. Public Proxy: The re-signature key can be kept as a secret in a private proxy scheme, but can be recomputed by observing the proxy passively in a public proxy scheme.
4. Transparent: In a transparent scheme, a signature transformed by a proxy is computationally indistinguishable from a signature on the same message signed by the delegator.
5. Key-Optimal: In a key-optimal scheme, a user is required to protect and store only a small constant amount of secrets no matter how many signature delegations the user gives or accepts.
6. Non-interactive: The delegatee is not required to participate in delegation process.
7. Non-Transitive: A re-signing right cannot be re-delegated by the proxy alone.
8. Temporary: A re-signing right is temporary. Typically, this is accomplished by revoking the right after some temporary period or expiring the right.

Many applications have been proposed for using proxy re-signatures, including, for example, providing a proof for a path that has been taken; managing group signatures; simplifying certificate management; simplifying key management; Digital Rights Management (DRM) interoperable systems; privacy for public transportation; “fair exchange” proxy re-signature based contract signing protocols; etc.

Proxy re-signatures were originally introduced 1998 as a bidirectional, multi-use, and public proxy scheme. This original proxy re-signature required the calculation of k exponentiations in both the delegatee's signature generation and the proxy's transformation, where k is a security parameter input, which is suggested to be at least 160 bits for discrete logarithm-based schemes. Unfortunately, this original proxy re-signature scheme is considered to be inefficient, and, as such, it is generally considered to be unsuitable for many practical applications.

More recent proxy re-signature schemes have been based on bilinear maps, and are generally considered to be more suitable for various practical applications. For example, one such proxy re-signature scheme is both multi-use and bidirectional, while another such scheme is single-use and unidirectional. Both schemes are more efficient than the original proxy re-signature scheme. However, these proxy re-signature have several disadvantages that generally limit their utility for various applications.

For example, typical proxy re-signature schemes are not proven to be secure, unidirectional, and private. One proxy re-signature scheme is proven secure and unidirectional, but it is of public proxy. Unfortunately, many applications such as contract signing protocols require the underlying proxy re-signature scheme to be a private proxy. Further, none of the aforementioned proxy re-signature schemes is both unidirectional and multi-use simultaneously. Unfortunately, applications such as the proof of a taken path mentioned require the underlying proxy re-signature scheme to be simultaneously unidirectional and multi-use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “proxy re-signature system,” as described herein, provides a multi-use unidirectional proxy re-signature process, denoted as Sₘᵤ, where a signature can be transformed in only one direction and can be re-transformed multiple times. In various embodiments, the proxy re-signature system provides either secure random oracle based re-signatures or secure re-signatures that do not rely on random oracles.

More specifically, in various embodiments, the proxy re-signature system provides various techniques for transforming a delegatee's signature on a message m into a delegator's on message m. In other words, assuming Bob's permission, the re-signature capability provided by the proxy re-signature system allows a message signed by Alice to be automatically re-signed using Bob's signature. Various combinations of the proxy re-signature techniques enabled by the proxy re-signature system provide an overall process that is unidirectional, multi-use, private, and non-interactive. As such, the proxy re-signature system is applicable for use with a wide range of applications.

The proxy re-signature system takes one of three basic forms, with various embodiments and modifications of each of the three basic forms. However, one important feature of all of these basic forms, is that the proxy re-signature system is collusion-resistant. In other words, the delegator (or delegatee) cannot collude with the proxy to produce the signatures that they have no privilege or are not authorized to produce. This property is advantageous since, in some applications, the secret keys of encryption and signature are the same, and, if this property is held, Alice can delegate signing rights to either the proxy or to Bob while keeping the decryption rights.

For example, one of the three basic forms of the proxy re-signature system provides various non-interactive message re-signature techniques under a random oracle model. In this first basic form of the proxy re-signature system, only the delegator, i.e., Bob, is required use his secret key with the public key of the delegatee, i.e., Alice, to generate the re-signature key and delegates the re-signature key to the proxy to transform the signature of the delegatee on some message to the signature of the delegator on that same message.

A second basic form of the proxy re-signature system provides various non-interactive message re-signature techniques under a random oracle model. In this second basic form of the proxy re-signature system, only the delegator (e.g., Bob) is required to use his secret key to generate the re-signature key to transform the delegatee's signature on some message to the delegator's on that same message, while only a public key is required from the delegatee (e.g., Alice). In this case, assuming Bob's permission, Alice's signature is transformed on the message into Bob's signature using Bob's private key and Alice's public key.

Finally, a third basic form of the proxy re-signature system provides various non-interactive message re-signature techniques under the standard model (i.e., no random oracles). In this third basic form of the proxy re-signature system, the re-signature key is generated in a similar way as the other two basic forms: delegator Bob uses his private key and the public key of delegatee Alice to generate the re-signature key and delegates the re-signature key to the proxy to transform the signature of the delegatee (i.e., Alice) on some message to the signature of the delegator (i.e., Bob) on that same message.

Note that as is well known to those skilled in the art of cryptography, a “random oracle” is a theoretical black box (typically implemented as a mathematical algorithm) that responds to every query with a random response chosen uniformly from its output domain, except that for any specific query, it responds the same way every time it receives that query. In other words, a random oracle is a mathematical function mapping every possible query to a random response from its output domain.

In view of the above summary, it is clear that the proxy re-signature system described herein provides various unique techniques for automatically and securely re-signing messages by transforming the signature of a delegatee to that of a delegator using collusion resistant re-signature processes. In addition to the just described benefits, other advantages of the proxy re-signature system will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of a “proxy re-signature system” as described herein.

FIG. 2 provides a general system flow diagram that illustrates exemplary methods for implementing a random oracle model embodiment of the proxy re-signature system, as described herein.

FIG. 3 provides a general system flow diagram that illustrates exemplary methods for implementing an alternative random oracle embodiment of the proxy re-signature system, as described herein.

FIG. 4 provides a general system flow diagram that illustrates exemplary methods for implementing a standard model embodiment of the proxy re-signature system, as described herein.

FIG. 5 is a general system diagram depicting a simplified general-purpose computing device having simplified computing and I/O capabilities for use in implementing various embodiments of the proxy re-signature system, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

### 1.0 Introduction

The first known proxy re-signature scheme in was introduced 1998, and was a bidirectional, multi-use, and public proxy scheme. The definition for security in proxy re-signature schemes was first formalized in a well known publication in 2005 entitled “Proxy re-signatures: new definitions, algorithms, and applications,” by G. Ateniese, S. and Hohenberger, in Proceedings of the 12th ACM Conference on Computer and Communications Security (Alexandria, Va., Nov. 7-11, 2005), ACM CCS 2005, pages 310-319.

In general, Ateniese and Hohenberger formalized the definition of security for a proxy re-signature (referred to herein as the “AH model”), and then proposed two proxy re-signature schemes of proven security based on bilinear maps and more applications of proxy re-signatures. The AH model describes both single-use unidirectional proxy re-signatures, denoted as “Sᵤₙᵢ,” and multi-use bidirectional proxy re-signatures, denoted as “S_{bi}.” In conventional unidirectional proxy re-signature schemes, there are two types of signatures: the first-level signature produced only by the signer, and the second-level signature produced by either the signer or collaboration between the signer's proxy and a delegatee. However, in conventional bidirectional proxy re-signature schemes, there is only one type of signature.

The AH model generally covers two types of forgeries for multi-use bidirectional proxy re-signatures (i.e., S_{bi} schemes): (1) an outsider who is neither the proxy nor one of the delegation parties aims to produce signatures on behalf of either delegation party; and (2) the proxy aims to produce signatures on behalf of either delegation party. In contrast, for single-use unidirectional proxy re-signatures (i.e, Sᵤₙᵢ schemes), the AH model includes the two types of forgeries noted above with respect to multi-use bidirectional proxy re-signatures, in addition to two additional types of forgeries, including: (3) the delegator colludes with the proxy to produce signatures on behalf of the delegatee; and (4) the delegatee colludes with the proxy to produce the first-level signatures.

Unfortunately, for unidirectional proxy re-signatures, the AH model does not cover all types of forgeries. For example, in a unidirectional proxy re-signature, the delegatee can attempt a forgery by fraudulently producing second-level signatures on behalf of the delegator. This type of forgery is not covered by the AH model, thereby making the AH model subject to attacks based on vulnerabilities relating to such forgery types.

Consequently, in various embodiments, a “proxy re-signature system,” as described herein provides a modified security model for proxy re-signatures that protects against additional forgery cases not covered by conventional proxy re-signature schemes. For example, the conventional AH model cannot cover attacks on unidirectional schemes in which the delegatee may attempt to produce a second-level signature on an arbitrary message on behalf of the delegator. This modified security model is referred to herein as the “proxy re-signature system security model.”

More specifically, given the following transformation path for a message: Alice→Proxy→Bob, Alice may fraudulently attempt to produce a second-level signature on the message on behalf of Bob. In this case, production of a second-level signature by Alice on behalf of Bob is fraudulent since Bob has delegated his signing rights to Proxy but not to Alice. While conventional proxy re-signature schemes are vulnerable to such attacks, the proxy re-signature system described herein provides an improved security model that is resistant to such attacks in the case of unidirectional proxy re-signatures.

In addition, in various embodiments, the proxy re-signature system provides a proven secure, multi-use, non-interactive, and unidirectional proxy re-signature scheme, denoted as “Sₘᵤ”. In particular, a random oracle based security proof for Sₘᵤ is provided based on various assumptions, including the well known “Computational Diffie-Hellman” (CDH) assumption and the well known “weaker Computational Diffie-Hellman” (wCDH) assumption. In related embodiments, the Sₘᵤ proxy re-signature process is further modified to produce an additional proxy re-signature process, denoted as Sₘᵤ*,” which is proved to be secure without relying on random oracles. The underlying assumptions used in proving the security of the Sₘᵤ * proxy re-signature process include the aforementioned CDH assumption and the well known “Extended Computational Diffie-Hellman” (ECDH) assumption.

Note that as is well known to those skilled in the art of cryptography, a “random oracle” is a theoretical black box (typically implemented as a mathematical algorithm) that responds to every query with a random response chosen uniformly from its output domain, except that for any specific query, it responds the same way every time it receives that query. In other words, a random oracle is a mathematical function mapping every possible query to a random response from its output domain.

### 1.1 System Overview:

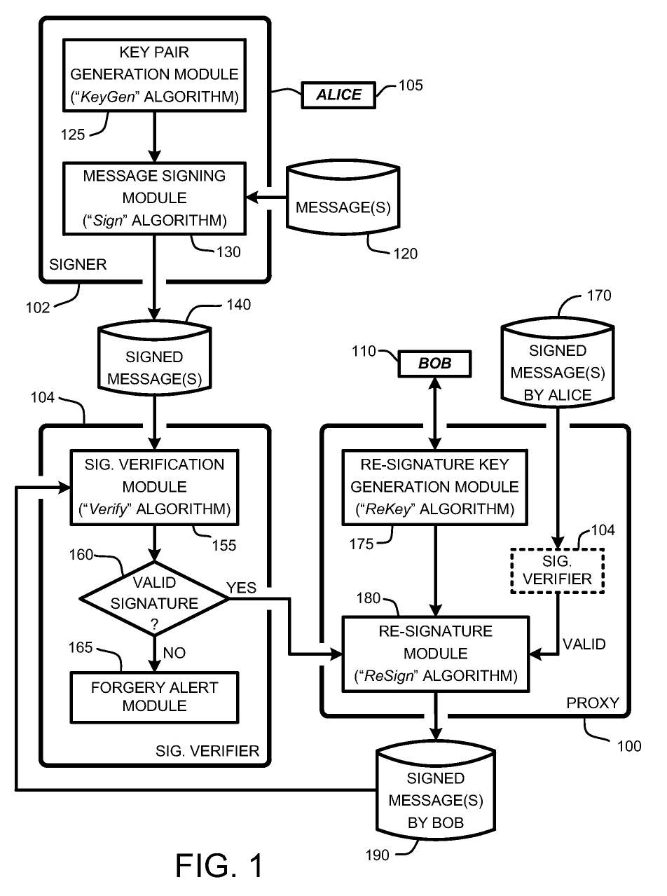

As noted above, the proxy re-signature system provides various techniques for automatically and securely re-signing messages by transforming the signature of a delegatee to that of a delegator using various collusion resistant re-signature processes. The processes summarized above are illustrated by the general system diagram of FIG. 1. In particular, the system diagram of FIG. 1 illustrates the interrelationships between program modules for implementing various embodiments of the proxy re-signature system, as described herein. Furthermore, while the system diagram of FIG. 1 illustrates a high-level view of various embodiments of the proxy re-signature system, FIG. 1 is not intended to provide an exhaustive or complete illustration of every possible embodiment of the proxy re-signature system as described throughout this document.

In addition, it should be noted that any boxes and interconnections between boxes that are represented by broken or dashed lines in FIG. 1 represent alternate embodiments of the proxy re-signature system described herein, and that any or all of these alternate embodiments, as described below, may be used in combination with other alternate embodiments that are described throughout this document.

In general, as illustrated by FIG. 1, the proxy re-signature system consists of three major parts: a signer 102, a signature verifier 104, and re-signature proxy 100. The signer 102 signs messages with its private key. The signer 102 can be a delegatee, referred to herein as Alice 105, or a delegator, referred to herein as Bob 110. The signature verifier 104 verifies authenticity of signed messages. The re-signature proxy 100 transforms the delegatee's signature on a message to a delegator's signature on that same message. It begins operation by the delegator Bob 110 to use his private key and the delegate Alice's 105 public key to generate a re-signature key, and then to communicate with the proxy to delegate the re-signature key to the proxy to transform Alice's signature on a message to Bob's signature on that same message.

In various embodiments, as described in further detail in Section 3, the transformation from Alice's 105 signature to Bob's 110 signature depends only on the re-signature key, and does not directly require one or more of Alice's and/or Bob's private keys. In re-signature key generation module 175, delegator Bob 110 uses his private key and delegatee Alice's 105 public key to generate the re-signature key and delegates the re-signature key to proxy 100.

In general, as described with respect to various embodiments of a “KeyGen” algorithm in Section 3.1, Section 3.4 and Section 3.5, the signer 102 first uses a key pair generation module 125 to generate a pair of keys (public key and private key), pk=g^{a} and sk=a, from the input of a security parameter, 1^{k}, which is used to select a random number a ε Z_{q}* using a conventional discrete logarithm-based key generation algorithm. Note that in some embodiments, the resulting key pair is used for a long time, while in other embodiments, the resulting key pair is temporary, and will expire after some predetermined period of time, or after one or more uses, as desired, in order to provide enhanced security.

Next, assuming that an unsigned message 120 is received by Alice 105, a message signing module 130 is used to securely sign the unsigned message 120 with Alice's signature. Note that depending upon the particular form of the proxy re-signature system (i.e., random-oracle model, alternative random-oracle model, or standard model, as described in further detail below), the signature is determined in different ways, which require either private or public keys. Specifically, the various forms of the signature produced on the message 120 by the message signing module 130 are described with respect to various embodiments of a “Sign” algorithm in Section 3.1, Section 3.4 and Section 3.5. Further, it should be noted that each signature can be either an owner-type signature, or a non-owner-type signature. See Section 2.1.2 for a discussion of signature types.

Next in the signature verifier 104, a signature verification module 155 evaluates signed messages. This signed message can be a message 140 signed directly by the signer, such as delegatee Alice 105 or delegator Bob 110, or a re-signed message 190 provided by the re-signature proxy 100. and the signature verification module 155 determines 160 whether that signature is valid. Note that depending upon the signature type and the particular embodiment of the proxy re-signature system, different signature validation techniques are required. For example, several of the various signature validation embodiments are described with respect to various embodiments of a “Verify” algorithm in Section 3.1, Section 3.4 and Section 3.5. In any case, if the signature is determined to be invalid 160, then a forgery alert module 165 terminates the verification process. Note that, if desired, the forgery alert module 165 can perform additional actions such as notifying the signer and/or one or more third parties of the attempted forgery, etc.

In one embodiment, the re-signature proxy 100 consists of three modules: the re-signature key generation module 175, the optional signature verifier 104, and re-signature module 180. In the re-signature key generation module 175 delegator Bob 110 uses his private key and delegatee Alice's 105 public key to generate a re-signature key using a “ReKey” algorithm, and then delegates this re-signature key to proxy 100. More specifically, in various embodiments, as described with respect to various embodiments of a “ReKey” algorithm in Section 3.1, Section 3.4 and Section 3.5, the re-signature key generation module 175 constructs the re-signature key non-interactively using various combinations of Alice's 105 public key and Bob's 100 private key.

For a message 170 signed by Alice 105, the signature verifier 104 inside the re-signature proxy 100 can optionally verify Alice's signature on the message before passing it to the re-signature module 180. If Alice's 105 signature is determined 160 to be invalid, forgery alert module 165 inside the signature verifier 104 terminates the re-signature process, and may send alert relevant parties of the forgery. However, assuming that the signature verifier 104 determines 160 that the signature on the message is valid, the re-signature module 180 then acts to transform Alice's 105 signature on the signed message 170 into Bob's 110 signature, resulting in message 190 signed by Bob. Note that Alice's 105 signed message 170 can be a message 140 signed directly by Alice or re-signed by a proxy to transform somebody else's signature into Alice's signature on a message. Again, depending upon the signature type and the particular embodiment of the proxy re-signature system, different signature transformation techniques are required. For example, several of the various signature transformation embodiments are described with respect to various embodiments of a “ReSign” algorithm in Section 3.1, Section 3.4 and Section 3.5.

Next, having transformed Alice's 105 signature 170 on a message 120 into Bob's 110 signature on that message, the re-signature proxy 100 outputs the re-signed message 190 for use as desired.

Finally, it should be noted that having transformed Alice's 105 signature 170 on a message 120 into Bob's 110 signature on that message, the resulting message 190, having Bob's signature, can be processed to transform Bob's signature to that of another party. For example, in this case, Bob 110 would act as the delegatee with respect to the signed message 190. That message 190 would then be processed in the manner described above with respect to message 140 or 170 to transform Bob's signature to that of some third party delegator.

### 2.0 General Definitions and Considerations

The following paragraphs describe various considerations, definitions, and proofs used to provide a detailed description of the proxy re-signature system.

### 2.1 Unidirectional Proxy Re-Signature (Definition 1)

A unidirectional proxy re-signature process S consists of the following five random algorithms: KeyGen, ReKey, Sign, ReSign, and Verify where:
1. KeyGen: The KeyGen algorithm provides conventional random generation of signature keys. Note that such techniques are well known to those skilled in the art, and will not be described in detail herein.
2. Sign: The Sign algorithm provides conventional message signing techniques for attaching a signature to a message. Note that such techniques are well known to those skilled in the art, and will not be described in detail herein.
3. Verify: The Verify algorithm provides conventional signature verification techniques. Note that such techniques are well known to those skilled in the art, and will not be described in detail herein.
4. ReKey: The ReKey algorithm takes as input delegatee Alice's key pair (pk_{A},sk_{A}), where pk_{A} is Alice's public key and sk_{A} is Alice's private or secure key, and delegator Bob's key pair (pk_{B},sk_{B}), where pk_{B} is Bob's public key and sk_{B} is Bob's private or secure key. Note that in various embodiments, Alice's private key, sk_{A} is optional. Then, given the input of (pk_{A},sk_{A}) and (pk_{B},sk_{B}), the ReKey algorithm returns a re-signing key “rk_{A→B}” for the proxy. In other words, the ReKey algorithm can be denoted as illustrated by Equation 1, where:

rk_{A→B}←ReKey(pk_{A},sk_{A},pk_{B},sk_{B}) Equation 1
5. ReSign: The ReSign algorithm takes as input a re-signature key rk_{A→B} and a signature σ_{A} (from Alice) on a message m corresponding to pk_{A}, and returns the signature σ_{B} (from Bob) on the same message m corresponding to pk_{B} as long as Alice's signature, σ_{A}, can be verified for the message m using Alice's private key pk_{A}, (i.e., as long as Verify(pk_{A},m,σ_{A})=1). If Alice's signature cannot be verified, then the ReSign algorithm returns a failure case denoted by “⊥” (i.e., message m will not be resigned using Bob's signature, σ_{B}). In other words, the ReSign algorithm can be denoted as illustrated by Equation 2, where:

σ_{B}←ReSign(rk_{A→B},pk_{A},m,σ_{A}) Equation 2

### 2.1.1 Correctness

In general, the idea of “correctness” is a conventional concept for determining whether a proxy re-signature is correct. In particular, for any message m in the message space and any two key pairs (pk_{A},sk_{A}) and (pk_{B},sk_{B}), let σ_{A} be a signature on message m corresponding to pk_{A} either from Sign or ReSign (see Section 2.1) Then, in order to guarantee that all signatures produced by either Sign or ReSign pass verification for correctness, the following two equations must both hold:

Verify(pk_{A},m,σ_{A})=1 Equation 3

Verify(pk_{B},m,ReSign(rk_{A→B},pk_{A},m,σ_{A}))=1 Equation 4

### 2.1.2 Types of Signatures

In conventional unidirectional proxy re-signature schemes, a signature may manifest in two types: the owner-type (also conventionally referred to as the “first-level” signature) and the non-owner-type (also conventionally referred to as the “second-level” signature). An owner-type signature can be computed only by the owner of the secret key, while a non-owner-type signature can be computed not only by the owner of the secret key, but also by collaboration between his proxy and delegatee.

### 2.2 Security of Unidirectional Proxy Re-Signature

In general, the proxy re-signature system provides a security model that improves over conventional proxy re-signature techniques by ensuring that various forgery cases that were unprotected using conventional techniques are prevented by the improved security model of the proxy re-signature system. In other words, the security model of the proxy re-signature system provides improved delegator security for unidirectional proxy re-signatures. Specifically, the improved security model ensures that a signature on a particular message cannot be modified to become another signature on the same message.

### 2.2.1 External Security

External security deals with “adversaries” (e.g., those who are attempting to perpetrate a forgery) other than the proxy and any delegation parties. In general, a unidirectional proxy re-signature scheme has external security if and only if for security parameter k, any non-zero n ε poly(k), and all probabilistic polynomial time (PPT) algorithms A, the following probability is negligible:

Pr[{pkᵢ,skᵢ}←KeyGen(1^{k})}_{iε[1,n]},

(t,m,σ)←A^{O}^{_{sign}}^{(•,•),O}^{_{resign}}^{(•,•,•,•)}({pkᵢ}_{iε[1,n]}):

Verify(pkₜ,m,σ)=1 [symbol] (t,m) ∉ Q] Equation 5

where oracle, O_{sign}, takes as input a public key pkᵢ and a message m ε M, and produces an output Sign(skᵢ,m); oracle “O_{resign}” takes as input two distinct public keys pkᵢ and pkⱼ, a message m, and a signature σ, and produces an output ReSign(ReKey(pkᵢ,skᵢ,pkⱼ,skᵢ),pkᵢ,m,σ); and Q denotes the set of (index,message) pairs (i,m) that A (i.e., Alice) obtains a signature on an message m under the public key pkᵢ by querying O_{sign} on (pkᵢ,m) or querying O_{resign} on (•,pkᵢ,m,•)

### 2.2.2 Internal Security

Internal security protects a user from inside adversaries who can be any parties, i.e., the proxy, the delegatee, and the delegator, in a proxy re-signature. Internal security can be classified into the following three types:

Limited Proxy: In the case of a limited proxy, the adversary is considered to be user A (i.e., Alice). The proxy re-signature system must guarantee that the proxy cannot produce signatures on behalf of either the delegator or the delegatee except the signatures produced by the delegatee and delegated to the proxy to re-sign. Internal security in this case is very similar to the external security described above, except that A queries a rekey oracle O_{rekey} instead of a re-signing oracle O_{resign}. A unidirectional proxy re-signature scheme is said to have limited proxy security if and only if for security parameter k, any non-zero n ε poly(k), and all PPT algorithms A, the following probability is negligible:

Pr[{pkᵢ,skᵢ}←KeyGen(1^{k})}_{iε[1,n]},

(t,m,σ)←A^{O}^{_{sign}}^{(•,•),O}^{_{rekey}}^{(•, •)}({pkᵢ}_{iε[1,n]}):

Verify(pkᵢ,m,σ)=1 [symbol] (t,m) ∉ Q], Equation 6

where O_{sign} is the same as those in external security, oracle O_{rekey} takes as input two distinct indices 1≦i,j≦n and returns the output of ReKey(pkᵢ,skᵢ,pkⱼ,skⱼ); and Q denotes the set of (index,message) tuples (i,m) that A obtained a signature on m under public key pkₜ or one of its delegatees' keys by querying oracle O_{sign}.

Delegatee Security: In the case of delegatee security, it is assumed that the proxy and delegator may collude with each other to perpetrate a forgery. Thus, delegatee security guarantees that any attempted collusion between the proxy and delegator cannot produce any unauthorized signatures on behalf of the delegatee. A unidirectional proxy re-signature scheme is said to have delegatee security if and only if for security parameter k, any non-zero n ε poly(k), and all PPT algorithms A, the following probability is negligible:

Pr[{pkᵢ,skᵢ}←KeyGen(1^{k})}_{iε[0,n]},

(m,σ)←A^{O}^{_{sign}}^{(0,•),O}^{_{rekey}}^{(ω,Λ)}(pk₀,{pkᵢ,skᵢ}_{iε[1,n]}):

Verify(pk₀,m,σ)=1 [symbol] (0,m) ∉ Q], Equation 7

where index 0 denotes the delegatee, Λ≠0, and Q is the set of pairs (0,m) that A obtains a signature by querying oracle O_{sign} on (0,m).

Delegator Security: There are several considerations with respect to delegator security. As such, several terms are first defined before describing delegator security concerns:
1. Delegation Chain: If user A delegates his signing rights to user B via a proxy P, then both user A and user B are said to be in a delegation chain, denoted as (B,A).
2. Delegation Predecessor: User B is called user A's delegation predecessor in the case that user A delegates his signing rights to user B.
3. Delegation Pair: The combination of the proxy and a user, either the delegatee B or the delegator A, is called a delegation pair. Therefore, user A and proxy P is a delegation pair. Similarly, user B and proxy P are also a delegation pair.

If user A delegates his signing rights to user B via a proxy P, and user B delegates his signing rights to user C via a proxy P′, then user A and user C are said to be in a delegation chain too. User C is also called user A's delegation predecessor. In this case, users A,B,C are in a delegation chain (C,B,A). The delegation chains (B,A) and (C,B) are delegation subchains of the delegation chain (C,B,A). A delegation chain is also its own subchain. The ending user of a delegation subchain is called the terminal of that delegation subchain. For example, user A is the terminal of the delegation subchain (C,B,A). If two users A and B are in a delegation chain and B is A's delegation predecessor, then B's signature can be transformed by a proxy or proxies into A's signature.

In terms of delegator security, there are two cases in which the proxy and the delegatee may collude with each other to perpetrate a forgery. These two cases are described in the following paragraphs.
1. All Proxies and Users (APU): In this case, all the proxies and delegation predecessors in every delegation subchain of which a target user is the terminal are considered to be malicious. The goal of this security is to guarantee that collusion among all these proxies and the delegation predecessors cannot produce any owner-type signatures on behalf of the target user. Note that if the owner-type signature and the non-owner-type signature are of the same form, then there is no such security. A unidirectional proxy re-signature scheme is said to have APU security if and only if for security parameter k, any non-zero n ε poly(k), and all PPT algorithms A, the following probability is negligible:

Pr[{pkᵢ,skᵢ}←KeyGen(1^{k})}_{iε[0,n]},

(m,σ)←A^{O}^{_{sign}}^{(•,•),O}^{_{rekey}}^{(•,•)}:

Verify(pk₀,m,σ)=1 [symbol] (0,m) ∉ Q], Equation 8
where index 0 denotes the target user (delegator), σ is an owner-type signature, and Q is the set of pairs (0,m) that A obtains a signature by querying oracle O_{sign} on (0,m). Note that, by working together, all the proxies and all the delegation predecessors in a delegation subchain of which a target user is the terminal can always produce the target user's non-owner-type signatures since the target user (delegator) delegates his signing rights to his delegation predecessor(s) via one or more proxies.
2. Not all Proxies and Users (NAPU): In this case, for every delegation subchain of which a target user is the terminal, if there is a corrupted delegation predecessor, then there is at least one uncorrupted delegation pair between the corrupted user and the target user. An uncorrupted delegation pair can be the target user and his proxy. Thus, this security guarantees that collusion among all the proxies and all the delegation predecessors except one delegation pair between corrupted users and the target user in every delegation subchain of which the target user is the terminal cannot produce any signatures, either owner-type or non-owner-type, on behalf of the target user. NAPU security will exist for a unidirectional proxy re-signature scheme if and only if for security parameter k, any non-zero n ε poly(k), and all PPT algorithms A, the following probability is negligible:

Pr[{pkᵢ,skᵢ}←KeyGen(1^{k})}_{iε[0,n]},

(m,σ)←A^{O}^{_{key}}^{(•),O}^{_{sign}}^{(•,•),O}^{_{rekey}}^{(•,•),O}_{resign}^{(•,•,•,•)}

(pk₀,{pkᵢ}_{iε[1,n]}): Verify(pk₀,m,σ)=1 [symbol] m ∉ Q], Equation 8
where index 0 denotes the target user (delegator), the key generation oracle O_{key}(•) takes i (i ε [1,n]) as input, and outputs the secret key skᵢ corresponding to pkᵢ, and Q is the set of messages m that A obtains a signature by querying oracle O_{sign} on (0,m), and a signature by querying oracle O_{resign} on (pkᵢ,pkⱼ,m,•), where pkᵢ or pkⱼ is in the uncorrupted delegation pair \hat{P}_{d} which is described below. Furthermore, there are two constraints on oracle O_{key}(•) and oracle O_{rekey}(•,•). As mentioned above, there exists at least one uncorrupted delegation pair \hat{P}_{d} between corrupted users and the target user in every delegation subchain of which the target user is the terminal. Thus, the first constraint is that the user in the uncorrupted delegation pair \hat{P}_{d} cannot be taken as an input to O_{key}(•). The second constraint is that the user in \hat{P}_{d} and the user who forms a delegation relationship with the user and the proxy in the delegation pair \hat{P}_{d} cannot be taken as an input to O_{rekey}(•,•). The combination of these two constraints does not allow the input to O_{rekey}(•,•) to form a delegation subchain ending with the target user. Otherwise by working together they can produce the target user's non-owner-type signatures, which is the goal of proxy re-signature. Note that the aims of the adversary in the APU security and the NAPU security are different.

### 2.3 Bilinear Groups

Conventional bilinear maps and bilinear map groups are briefly reviewed in the following paragraphs for purposes of explanation. However, it should be noted that bilinear maps and bilinear map groups, as such, these concepts will not be discussed in detail. In particular, bilinear maps and bilinear map groups can be described in terms of the following definitions:
1. G and G_{T} are two (multiplicative) cyclic groups of prime order q;
2. g is a generator of G;
3. e is a bilinear map, e: G×G→G_{T}.

Let G and G_{T} be two groups as above. Then, an admissible bilinear map is a map e: G×G→G_{T} with the following properties:
1. Bilinearity: For all P,Q,R ε G, e(P·Q,R)=e(P,R)·e(Q,R) and e(P,Q·R)=e(P,Q)·e(P,R).
2. Non-degeneracy: If e(P,Q)=1 for all Q ε G, then P=O, where O is a point at infinity.

G is said to be a bilinear group if the group action in G can be computed efficiently and there exists a group G_{T} and an efficiently computable bilinear map as above. The term “BSetup” is used to denote an algorithm that, given an input of security parameter, 1^{k}, outputs parameters for a bilinear map as (q,g,G,G_{T},e), where q ε Θ(2^{k}).

### 2.4 Complexity Assumptions

The security of the various embodiments of the proxy re-signature system is based on the Computational Diffie-Hellman (CDH) assumption, the Strong Computational Diffie-Hellman (wCDH) assumption, and the Extended Computational Diffie-Hellman (ECDH) assumption.

### 2.4.1 CDH Problem

The CDH problem in a finite cyclic group G with prime order q is as follows: Given [symbol] g, g^{a}, g^{b} [symbol] for some a, b ε Z_{q}*, compute g^{ab}. An algorithm A has an advantage ε in solving the CDH problem if:

Pr[A(g,g^{a},g^{b})=g^{ab}]≧ε, Equation 9

where the probability is over random choices of a,b in Z_{q}*, a random choice of g ε G*, and the random bits of A.

CDH Assumption (Definition 2): The ε-CDH assumption is true if no PPT algorithm has an advantage of at least ε in solving the CDH problem.

2.4.2 wCDH Problem:

The wCDH problem in a finite cyclic group G with prime order q is as follows: Given [symbol] g,g^{a},g^{b},g^{c} [symbol] for some a,b,c ε Z_{q}*, compute g^{ab/c}. An algorithm A has advantage ε in solving wCDH problem if:

Pr[A(g,g^{a},g^{b},g^{c})=g^{ab/c}]≧ε, Equation 10

where the probability is over random choices of a,b,c in Z_{q}*, a random choice of g ε G*, and the random bits of A.

wCDH Assumption (Definition 3): The ε-wCDH assumption is true if no PPT algorithm has an advantage of at least ε in solving the wCDH problem.

Note that the wCDH assumption is a weaker version of the CDH assumption. If c=1, then it can be easily seen that the wCDH assumption is equivalent to the CDH assumption. Therefore, if the wCDH problem can be solved, than the CDH problem can also be solved.

2.4.3 ECDH Problem:

The ECDH problem in a finite cyclic group G with prime order q is as follows: Given [symbol] g,g^{a},g^{b},g^{c} [symbol] for some a,b,c ε Z_{q}*, compute g^{ab/c}. An algorithm A has advantage ε in solving ECDH problem if:

Pr[A(g,g^{a},g^{b},g^{c},g^{b/c})=g^{ab/c}]≧ε, Equation 11

where the probability is over random choices of a,b,c in Z_{q}*, a random choice of g ε G*, and the random bits of A.

ECDH Assumption (Definition 4): The ε-ECDH assumption is true if no PPT algorithm has an advantage of at least ε in solving the ECDH problem.

### 2.5 A Conventional Short Signature Scheme

A conventional short signature scheme for securely signing messages was proposed by authors Boneh, Lynn, and Shacham in two well known publications entitled:
1. “Short signatures from the Weil pairing” by D. Boneh, B. Lynn, and H. Shacham, in ASIACRYPT 2001, volume 2248 of LNCS, pages 514-532, 2001.
2. “Short signatures from the Weil pairing” by D. Boneh, B. Lynn, and H. Shacham, in J. Cryptol. 17, 4 (September 2004), 297-319.

In general, the authors of these two publications introduced a “short signature” scheme for use in secure signature applications. This short signature scheme is referred to herein as the “BLS” scheme. The public parameters of the BLS scheme are (q,g,G,G_{T},e), where (q,g,G,G_{T},e)←BSetup(1^{k}), and H is a cryptographic hash function: {0,1}*→G.

The BLS scheme generally makes use of three basic algorithms, including a KeyGen algorithm, a Sign, and a Verify algorithm, where:
1. KeyGen: The BLS-based KeyGen algorithm picks a random x from Z_{q}*, and computes y=g^{x}. The pubic key is y ε G and the private key is x.
2. Sign: The BLS-based Sign algorithm uses a key x and a message m ε [0,1}*, to generate a signature σ=H(m)^{x}. In other words, the BLS-based Sign algorithm can be denoted as illustrated by Equation 13, where:

σ←BLS.Sign(x,m) Equation 13
3. Verify: The BLS-based Verify algorithm Given a public key y ε G, a message m ε {0,1}*, and a signature σ, outputs 1 if e(y,H(m))=e(g,σ), or 0 otherwise. In other words, the BLS-based Verify algorithm can be denoted as illustrated by Equation 14, where:

BLS.Ver(σ,y,m) Equation 14

Theorem 1: If the CDH assumption is true for G, the BLS scheme is secure under adaptive chosen-message attacks in the random oracle model.

### 2.6 Modified Short Signature Process

In various embodiments, the proxy re-signature system provides a unique modification of the BLS scheme, referred to herein as the “mBLS” process. The public parameters of the mBLS process are the same as defined above for the BLS scheme. As with the BLS scheme, the mBLS process includes three basic algorithms, including a KeyGen algorithm, a Sign, and a Verify algorithm, where:
1. KeyGen: The mBLS-based KeyGen algorithm picks two random numbers x₁,x₂ from Z_{q}* (note that the BLS scheme used only a single random number) and computes y₁=g^{x}^{₁} and y₂=g^{x}^{₂}. The pubic key is y₁,y₂ ε G and the private key is x₁/x₂.
2. Sign: The mBLS-based Sign algorithm uses a key pair (x₁,x₂) and a message m ε {0,1}* to generate a signature σ=(H(m)^{x}^{₁}^{/x}^{₂}). In other words, the mBLS-based Sign algorithm can be denoted as illustrated by Equation 15, where:

σ←mBLS.Sign(x₁/x₂,m) Equation 15
3. Verify: The mBLS-based Verify algorithm receives the public key y₁,y₂ ε G, a message m ε {0,1}*, and a signature σ. Given these inputs, the algorithm outputs “1” if e(y₁,H(m))=e(y₂,σ), or “0” otherwise (i.e., verified (1), or not verified (0)). In other words, the mBLS-based Verify algorithm can be denoted as illustrated by Equation 16, where:

mBLS.Ver(σ,(y₁,y₂),m) Equation 16

Theorem 2: If the wCDH assumption is true for G, the mBLS process is secure under adaptive chosen-message attacks in the random oracle model.

### 2.7 A Conventional Signature Scheme Without Random Oracles

A conventional signature scheme that does not require the use of random oracles was introduced in a publication entitled “Efficient identity-based encryption without random oracles,” by B. Waters, in Advances in Cryptology, Eurocrypt 2005, volume 3494 of LNCS 3494, pp. 114-127, Springer-Verlag, 2005. This conventional identity-based encryption scheme, referred to herein as the “Waters scheme,” provides an efficient identity-based encryption scheme that is secure in the full model, without random oracles. The security of the Waters scheme was proved by reducing it to a decisional Bilinear Diffie-Hellman problem.

In various embodiments, the proxy re-signature system provides a unique modification (identified using the notation “S_{mu*}”) of the Waters scheme for use in providing proxy re-signatures. Consequently, the following paragraphs will generally describe the Waters scheme prior to introducing the unique modification to the Waters scheme.

In general, the public parameters of the Waters scheme are (q,g,G,G_{T},e), where (q,g,G,G_{T},e)←BSetup(1^{k}). The following terminology is used through the remainder of the detailed description: H_{w}(m)=u′·Π_{iεU}uᵢ, where U ⊂ {1, . . . ,nₘ} is the set of indices i such that m[i]=1, and m[i] is the i-th bit of m. As with other conventional secure signature schemes, the Waters scheme includes three basic algorithms, including a KeyGen algorithm, a Sign, and a Verify algorithm, where:
1. KeyGen: The KeyGen algorithm of the Waters scheme first selects a random number a from Z_{q}*, and nₘ+2 random numbers (g₂,u′,u₁, . . . ,uₙ_{ₘ}) from G, and outputs the key pair pk=g₁=g^{a} and sk=a, and the public parameters (G,G_{T},e,g₂,u′,u₁, . . . ,uₙ_{ₘ}).
2. Sign: The Sign algorithm of the Waters scheme receives an input of a secret key sk=a and a nₘ-bit message m. This Sign algorithm then outputs a signature σ=(A,B)=(g₂^{a}·H_{w}(m)^{r},g^{r}), where r is chosen randomly from Z_{q}*. In other words, the Sign algorithm of the Waters scheme can be denoted as illustrated by Equation 17, where:

σ←Waters.Sign(sk,m) Equation 17
3. Verify: The Verify algorithm of the Waters scheme receives an input of a public key, pk, a nₘ-bit message m, and a test signature σ=(A,B). The Verify algorithm of the Waters scheme then outputs “1” (i.e., true) if e(pk,g₂)e(B,H_{w}(m))=e(A,g), or 0 (i.e., false) otherwise. In other words, the Verify algorithm of the Waters scheme can be denoted as illustrated by Equation 18, where:

Waters.Ver(σ,pk,m) Equation 18

Theorem 3: If the CDH assumption is true for G, the Waters scheme is secure under adaptive chosen-message attacks in the standard model, without the use of random oracles

### 2.8 mWat Process

A process referred to herein as the “mWat” process of the proxy re-signature system provides a novel modification of the Waters scheme described in Section 2.7. The mWat process provides a secure process that enables various embodiments of the proxy re-signature system to perform proxy re-signature operations without the use of random oracles. As with other secure signature processes, the mWat process includes three basic algorithms, including a KeyGen algorithm, a Sign, and a Verify algorithm, where:
1. KeyGen: The KeyGen algorithm of the mWat process first selects a random number a from Z_{q}*, and nₘ+2 random numbers (g₂,u′,u₁, . . . ,uₙ_{ₘ}) from G. The KeyGen algorithm of the mWat process then outputs a key pair pk₁=g^{a}, pk₂=g^{b}, pk₃=g^{a/b} and sk=a/b, and the public parameters (G,G_{T},e,g₂,u′,u₁, . . . ,uₙ_{ₘ}).
2. Sign: The Sign algorithm of the mWat process receives an input of a secret key sk=a/b and a nₘ-bit message m. The Sign algorithm of the mWat process then outputs signature σ=(A,B,C)=(g₂^{a/b}·II_{w}(m)^{r},g^{r},g^{rb}), where r is chosen randomly from Z_{q}*. In other words, the Sign algorithm of the mWat process can be denoted as illustrated by Equation 19, where:

σ←mWat.Sign(sk,m) Equation 19
3. Verify: The Verify algorithm of the mWat process receives an input of a public key pk, a nₘ-bit message m, and a test signature σ=(A,B,C). The Verify algorithm of the mWat process then outputs “1” (i.e., true) if e(A,g)=e(H_{w}(m),B)e(g₂,pk₃), e(pk₂,B)=e(C,g), or “0” (i.e., false) otherwise. In other words, the Verify algorithm of the mWat process can be denoted as illustrated by Equation 20, where:

mWat.Sign(σ,(pk₁,pk₂,pk₃),m) Equation 20

Theorem 4: If the ECDH assumption is true for G, the mWat process is secure under adaptive chosen-message attacks in the standard model without the use of random oracles.

### 2.9 Security Failure Case for the AH Model

The following paragraphs describe an example of a proxy re-signature scheme that is proven to be secure under the AH model, but is proven to be insure under the proxy re-signature system security model described herein. In other words, the proxy re-signature system security model provides enhanced security relative to the conventional AH model.

In particular, the following paragraphs describe a unidirectional multi-use proxy re-signature process referred to herein as “Sᵤₘᵤ.” The Sᵤₘᵤ process is secure under the conventional AH model but insecure in the proxy re-signature system security model. This fact shows that the proxy re-signature system security model is more secure than the AH model.

The public parameters of scheme Sᵤₘᵤ are almost the same as those of the aforementioned BLS scheme, except that there are two hash functions in Sᵤₘᵤ: H₁,H₂: {0,1}*→G. As with other proxy re-signature schemes, the Sᵤₘᵤ scheme includes five basic algorithms, including: KeyGen, ReKey, Sign, ReSign, and Verify where:
1. KeyGen: Given an input of a security parameter, 1^{k}, the KeyGen algorithm of the Sᵤₘᵤ scheme selects a random number a ε Z_{q}*, and outputs the key pair pk=g^{a} and sk=a.
2. Re-Signature Key Generation (ReKey): Given an input of Alice's public key, pk_{A}=g^{a}, and Bob's private key sk_{B}=b, the ReKey algorithm of the Sᵤₘᵤ scheme outputs the re-signature key rk_{A→B}=(r,pkr_{A}^{r},H₂(pk_{A}^{r})^{b}), where r is a random number in Z_{q}* determined by Bob. Note that the re-signature key is generated by Bob and then delegated by Bob to the proxy. Due to the inherent security of the BLS scheme, no one expect Bob can generate a valid re-signature key to transform Alice's signature on a message to Bob's signature on that same message.
3. Sign: Given the input of a secret key sk=a and a message m, the Sign algorithm of the Sᵤₘᵤ scheme outputs an owner-type signature σ=H₁(m)^{a} or a non-owner-type signature σ=(s,A₁,B₁,A₂,B₂, . . . ,Aᵢ,Bᵢ), where s=H₁(m)^{r}^{₁}, Aⱼ=g^{r}^{ⱼ}(1≦j≦i), Bⱼ=H₂(Aⱼ)^{r}^{ⱼ}(1≦j<i), Bᵢ=H₂(Aᵢ)^{a}, and rⱼ (1≦j≦i) are random numbers in Z_{q}*.
4. ReSign: Given a re-signature key rk_{A→B}=(rk_{A→B}⁽¹⁾,rk_{A→B}⁽²⁾,rk_{A→B}⁽³⁾), a public key pk_{A}, a signature σ, and a message m, the ReSign algorithm of the Sᵤₘᵤ scheme first checks to determine whether Verify

$$Verify ( p {k}_{A} , m , σ ) {=}^{?} 1.$$

If the verification fails (i.e, Verify(pk_{A},m,σ)≠1), then the ReSign algorithm outputs ⊥; otherwise:
a. if σ is an owner-type signature, the ReSign algorithm outputs:

$$\begin{matrix}{σ}^{′} = ( {σ}^{{rk}_{A \to B}^{( 1 )}} , {rk}_{A \to B}^{( 2 )} , {rk}_{A \to B}^{( 3 )} ) \\ = ( {{H}_{1} ( m )}^{ra} , p {k}_{A}^{r} , {{H}_{2} ( p {k}_{A}^{r} )}^{b} ) .\end{matrix}$$

b. if σ is a non-owner-type signature, outputs:

$$\begin{matrix}{σ}^{′} = ( s , {A}_{1} , {B}_{1} , … , {A}_{i} , {( {B}_{i} )}^{{rk}_{A \to B}^{( 1 )}} , {rk}_{A \to B}^{( 2 )} , {rk}_{A \to B}^{( 3 )} ) \\ = ( s , {A}_{1} , {B}_{1} , … , {A}_{i} , {{H}_{2} ( {A}_{i} )}^{ra} , p {k}_{A}^{r} , {{H}_{2} ( p {k}_{A}^{r} )}^{h} )\end{matrix}$$

5. Verify: Given the input of a public key, pk, a message m, and a signature σ, the Verify algorithm of the Sᵤₘᵤ scheme outputs one of the following:
   a. if σ is an owner-type signature, the Verify algorithm checks

$$e ( σ , g ) {=}^{?} e ( {H}_{1} ( m ) , p {k}_{A} ) .$$

If the equation is true, the Verify algorithm outputs 1; otherwise, the Verify algorithm outputs 0.
b. if σ is a non-owner-type signature, the Verify algorithm evaluates the following conditions:

$$e ( s , g ) {=}^{?} e ( {H}_{1} ( m ) , {A}_{1} ) , \\ e ( {B}_{j} , g ) {=}^{?} e ( {H}_{2} ( {A}_{j} ) , {A}_{j + 1} ) ( 1 \leq j < i ) , \\ e ( {B}_{i} , g ) {=}^{?} e ( {H}_{2} ( {A}_{i} ) , p {k}_{A} )$$

then, if all the above conditions are true, the Verify algorithm outputs 1 (i.e., true, signature verified); otherwise, the Verify algorithm outputs 0 (i.e., false, signature not verified).

### 2.9.1 Security Considerations

Since the Sᵤₘᵤ scheme is implemented using the BLS scheme, conventional BLS proofs, including the oracles in the proof of the BLS scheme can be used to validate the security of the Sᵤₘᵤ scheme. In particular, a forgery under the BLS scheme can be identified when the adversary, attacking on scheme Sᵤₘᵤ, outputs a forgery of scheme Sᵤₘᵤ. As a result, the Sᵤₘᵤ scheme is secure in the AH model.

However, consider the following case: Alice→Proxy→Bob. First, Alice can produce a non-owner-type signature on m: σₐ=(H₁(m)^{r},g^{r},H₂(g^{r})^{a}), where Alice knows the value of r. Then, Proxy can transform Alice's signature, σₐ, into Bob's signature σ_{b}=(H₁(m)^{r},g^{r},H₂(g^{r})^{ar}^{_{A>B}},pk_{A}^{r}^{_{A>B}},H₂(pk_{A}^{r}^{_{A>B}})^{b}). In this case, Alice can generate signatures on any message, simply by changing m to m′, since Alice knows the value of r. This attack is defined in the security notion of NAPU (see the discussion regarding delegator security in Section 2.2.2). As a result, the Sᵤₘᵤ scheme is insecure under the proxy re-signature system security model.

In other words, while the Sᵤₘᵤ scheme appears to be secure under the conventional AH model, the proxy re-signature system security model shows that the Sᵤₘᵤ scheme is actually insecure. As such, the proxy re-signature system security model provides improved security for proxy re-signature operations.

### 3.0 Operational Details of the Proxy Re-Signature System

As noted above, the proxy re-signature system provides various techniques for automatically and securely re-signing messages by transforming the signature of a delegatee to that of a delegator using various collusion resistant re-signature processes. The following sections provide a detailed discussion of the operation of various embodiments of the proxy re-signature system, and of exemplary methods for implementing the program modules described in Section 1 with respect to FIG. 1, in view of the definitions and general considerations described in Section 2. In particular, the following sections describe examples and operational details of various embodiments of the proxy re-signature system, including: various non-interactive embodiments of the proxy re-signature system under the random oracle model; a security analysis and security considerations of the proxy re-signature system; reducing of re-signature size; various non-interactive embodiments of the proxy re-signature system with more efficiency under the random oracle model; and various non-interactive embodiments of the proxy re-signature system under the standard model (without the use of random oracles).

3.1 Random Oracle Model Version of Proxy Re-Signature System Sₘᵤ:

A random oracle-based embodiment of the proxy re-signature system, referred to herein as “Sₘᵤ” provides an improved version of Sᵤₘᵤ scheme that is proven to be secure under the proxy re-signature system security model (as well as being secure under other security models, such as the AH model). The pubic parameters of the Sₘᵤ process are almost the same as those of the Sᵤₘᵤ scheme, except for an additional hash function: H₃:{0,1}*→G. As with other proxy re-signature schemes, the Sₘᵤ proxy re-signature process includes five basic algorithms, including: KeyGen, ReKey, Sign, ReSign, and Verify where:
1. KeyGen: Given an input of a security parameter, 1^{k}, the KeyGen algorithm of the Sₘᵤ proxy re-signature process selects a random number a ε Z_{q}*, and outputs the key pair pk=g^{a} and sk=a.
2. Re-Signature Key Generation (ReKey): Given an input of Alice's public key pk_{A}=g^{a} and Bob's private key sk_{B}=b, the ReKey algorithm of the Sₘᵤ proxy re-signature process outputs the re-signature key rk_{A→B}=(r,pk_{A}^{r},II₃(pk_{A}^{r}∥pk_{A})^{b}), where r is a random number in Z_{q}* determined by Bob. This re-signature key is generated by Bob and then delegates to the proxy. Due to the inherent security of BLS scheme, no one expect Bob can generate a valid re-signature key to transform Alice's signature on a message to Bob's signature on that same message. Note that this ReKey algorithm can be described in terms of a unique modification to the BLS scheme as illustrated by Equation 21, where:

rk_{A→B}=(r,pk_{A}^{r},BLS.Sign(b,pk_{A}^{r}∥pk_{A})). Equation 21
3. Sign: Given the input of a secret key, sk=a (from either Alice or Bob) and a message, m, the Sign algorithm of the Sₘᵤ proxy re-signature process outputs an owner-type signature, σ=H₁(m)^{a}, or a non-owner-type signature σ=(s,A₁,B₁,C₁,D₁, . . . ,Aᵢ,Bᵢ,Cᵢ,Dᵢ), where Aⱼ=g^{a}^{ⱼ}, Bⱼ=g^{b}^{ⱼ}, Cⱼ=H₂(s)^{a}^{ⱼ}^{/b}^{ⱼ} for 1≦j≦i, and Dⱼ=H₃(gⱼ^{a}∥gⱼ^{b})^{a}^{ⱼ₊₁} for 1≦j<i, and Dᵢ=II₃(gᵢ^{a}∥gᵢ^{b})^{a}, and aⱼ and bⱼ (1≦i) are random numbers in Z_{q}* and s=H₁(m)^{a}^{₁}. Note that this Sign algorithm can be described in terms of a unique modification to the BLS scheme which uses the above-described mBLS process as illustrated by Equation 22, where:

Cⱼ=mBLS.Sign(aⱼ/bⱼ,s)(1≦j≦i),

Dⱼ=BLS.Sign(aⱼ₊₁,g^{a}^{ⱼ}∥g^{b}^{ⱼ})(1≦j<i),

Dᵢ=BLS.Sign(a,g^{a}^{ᵢ}∥g^{b}^{ᵢ}). Equation 22
4. Re-Sign: Given a re-signature key rk_{A→B}=(rk_{A→B}⁽¹⁾,rk_{A→B}⁽²⁾,rk_{A→B}⁽³⁾), a public key pk_{A}, the signature a generated by the above Sign algorithm, and the message m, the ReSign algorithm of the Sₘᵤ proxy re-signature process first determines whether the signature is valid by determining whether

$$Verify ( p {k}_{A} , m , σ ) {=}^{?} 1.$$

If the verification fails (i.e, Verify(pk_{A},m,σ)≠1), then the ReSign algorithm outputs ⊥; otherwise:
a. if σ is an owner-type signature, σ=H₁(m)^{a}, the ReSign algorithm outputs a transformed signature, σ′, in the form of σ′=(s,A,B,C,D), where:

$$s = {σ}^{{rk}_{A -> B}^{( 1 )}} = {{H}_{1} ( m )}^{ra} , A = {rk}_{A -> B}^{( 2 )} = p {k}_{A}^{2} , B = p {k}_{A} = {g}^{a} , \\ C = {{H}_{2} ( s )}^{{rk}_{A -> B}^{( 1 )}} = {{H}_{2} ( {{H}_{1} ( m )}^{ra} )}^{r} , D = {rk}_{A -> B}^{( 3 )} = {{H}_{3} ( p {k}_{A}^{r} \vert \vert p {k}_{A} )}^{b} .$$

b. if σ is a non-owner-type signature, σ=(s,A₁,B₁,C₁,D₁, . . . ,Aᵢ,Bᵢ,Cᵢ,Dᵢ), the ReSign algorithm outputs a transformed signature, σ′, in the form of

$${σ}^{′} ( s , {A}_{1} , {B}_{1} , {C}_{1} , {D}_{1} , … , {A}_{i} , {B}_{i} , {C}_{i} , {D}_{i}^{{rk}_{A -> B}^{( 1 )}} , {rk}_{A -> B}^{( 2 )} , p {k}_{A} , {{H}_{2} ( s )}^{{rk}_{A -> B}^{( 1 )}} , {rk}_{A -> B}^{( 3 )} ) , \\ where \text{:}$$

$${D}_{i}^{{rk}_{A -> B}^{( 1 )}} = {H}_{3} ( {g}^{{a}_{i}} \vert \vert {g}^{{b}_{i}} ) , {rk}_{A -> B}^{( 2 )} = p {k}_{A}^{2} , \\ {{H}_{2} ( s )}^{{rk}_{A -> B}^{( 1 )}} = {{H}_{2} ( s )}^{r} , {rk}_{A -> B}^{( 3 )} = {{H}_{3} ( p {k}_{A}^{r} \vert \vert p {k}_{A} )}^{b} .$$

Note that the ReSign algorithm can be described in terms of a unique modification to the BLS scheme in view of the above described mBLS process as follows:
a. if σ is an owner-type signature, then:

C=mBLS.Sign(r,s),

D=BLS.Sign(b,pk_{A}^{r}∥pk_{A})
b. if σ is a non-owner-type signature, then:

$${C}_{i + 1} = {{H}_{2} ( s )}^{{rk}_{A -> B}^{( 1 )}} = mBLS \cdot Sign ( r , s ) , \\ {D}_{i + 1} = {rk}_{A \to B}^{( 3 )} = BLS \cdot Sign ( b , p {k}_{A}^{r} \vert \vert p {k}_{A} ) .$$

5. Verify: Given the input of a public key, pk, the message m, and the signature σ, the Verify algorithm of the Sₘᵤ proxy re-signature process performs the following verifications:
   a. if σ is an owner-type signature, the Verify algorithm determines whether

$$e ( σ , g ) {=}^{?} e ( {H}_{1} ( m ) , p k ) .$$

If the equation is true, the Verify algorithm outputs 1; otherwise, the Verify algorithm outputs 0.
b. if σ is a non-owner-type signature, the Verify algorithm checks the following conditions, such that if each of the following conditions is true, the Verify algorithm outputs a “1” (i.e., verification successful). If any of the conditions is not true, the Verify algorithm outputs a “0” (i.e., verification failed).

$$e ( s , g ) {=}^{?} e ( {H}_{1} ( m ) , {A}_{1} ) , \\ e ( {C}_{j} , {B}_{j} ) {=}^{?} e ( {H}_{2} ( s ) , {A}_{j} ) ( 1 \leq j \leq i ) , \\ e ( {D}_{j} , g ) {=}^{?} e ( {H}_{3} ( {A}_{j} ‖ {B}_{j} ) , {A}_{j + 1} ) ( 1 \leq j < i ) , \\ e ( {D}_{i} , g ) {=}^{?} e ( {H}_{3} ( {A}_{i} ‖ {B}_{i} ) , p k ) .$$

Note that the Verify algorithm shown above can be described in terms of a unique modification of the BLS scheme and the mBLS process as shown below. Note that in each of the following two cases, if each of the following equations is true, the Verify algorithm outputs 1; otherwise, the Verify algorithm outputs 0:
1. If σ is an owner-type signature, then BLS.Ver(σ,pk,m).
2. If σ is a non-owner-type signature, then

BLS.Ver(s,A₁,m),

mBLS.Ver(Cⱼ,(Aⱼ,Bⱼ),s) (1≦j≦i),

BLS.Ver(Dⱼ,Aⱼ₊₁,Aⱼ∥Bⱼ)(1≦j<i),

BLS.Ver(Dᵢ,pk,Aᵢ∥Bᵢ).

### 3.2 Security Considerations of the Proxy Re-Signature System

Lemma 1: In the random oracle case, the Sₘᵤ proxy re-signature process is correct and secure if both the BLS scheme and the mBLS process are secure under adaptive chosen-message attacks.

Proof Summary: Since the Sₘᵤ proxy re-signature process is implemented by the BLS scheme and the mBLS process, security proofs of the Sₘᵤ proxy re-signature process can be achieved using the proofs of the BLS scheme and the mBLS process, as described above, particularly with respect to the oracles in the proofs of the BLS scheme and the mBLS process. Therefore, all oracles (with the exception of the rekey oracle, as discussed in Section 3.2.1) required by the proxy re-signature system security model can be answered. Furthermore, a forgery can always be identified with either the BLS scheme or the mBLS process when the adversary, attacking Sₘᵤ, outputs a forgery of Sₘᵤ. As a result, the Sₘᵤ proxy re-signature process is secure under the proxy re-signature system security model.

### 3.2.1 Re-Signature Key Generation Oracle

In view of Theorem 1 and Theorem 2 (see Section 2.5 and Section 2.6, respectively, there are several random oracles, as described below. As noted above, a random oracle is a theoretical black box (typically implemented as a mathematical algorithm) that responds to every query with a random response chosen uniformly from its output domain, except that for any specific query, it responds the same way every time it receives that query. In other words, a random oracle is a mathematical function that maps every possible query to a random response from its output domain.
1. BLS.KeyGen: Given an input of the security parameter 1^{k}, the BLS.KeyGen oracle outputs a public key pk.
2. BLS.H: Given an input of a string m, the BLS.H oracle outputs a random number R in G.
3. BLS.Sign: Given an input of a public key, pk, and a message m, the BLS.Sign oracle outputs a BLS signature, σ.
4. mBLS.KeyGen: Given an input of the security parameter 1^{k}, the mBLS.KeyGen oracle outputs a public key (pk₁,pk₂).
5. mBLS.H: Given an input of a string, m, the mBLS.H oracle outputs a random number R in G.
6. mBLS.Sign: Given an input of a public key (pk₁,pk₂) and a message m, the mBLS.Sign oracle outputs an mBLS signature σ.

Note that that running the BLS.KeyGen oracle twice is equivalent to running the mBLS.KeyGen oracle once. Note also that the following discussion uses the BLS.H oracle to answer the two random oracles O_{H}_{₁} and O_{H}_{₃}, however, the proxy re-signature system requires that on the same input, the outputs of O_{H}_{₁} and O_{H}_{₃} are different in order to maintain security.

### 3.2.2 Limited Proxy

For each query on O_{rekey} on the input (pkᵢ,pkⱼ), the Challenger (either Alice or Bob, depending upon the circumstances) searches for the tuple (pkᵢ,pkⱼ,Λ₁,Λ₂,Λ₃) in table Tᵣₖ.

If this tuple, (pkᵢ,pkⱼ,Λ₁,Λ₂,Λ₃) does not exist, the Challenger chooses a random number rᵢⱼ from Z_{q}*, computes Rᵢⱼ=(pkᵢ)^{r}^{ᵢⱼ}, and returns (rᵢⱼ,Rᵢⱼ,BLS.Sign(pkⱼ,(Rᵢⱼ∥pkᵢ)). The Challenger then records (pkᵢ,pkⱼ,rᵢⱼ,Rᵢⱼ,BLS.Sign(pkⱼ,(Rᵢⱼ∥pkᵢ))) into table Tᵣₖ. Note that Rᵢⱼ ε {R|R←BLS.KeyGen(1^{k})}, and BLS.Sign(pkⱼ,(Rᵢⱼ∥pkᵢ)) are associated with the random oracle O_{H}_{₃}.

However, if this tuple, (pkᵢ,pkⱼ,Λ₁,Λ₂,Λ₃), does exist, the Challenger just returns (Λ₁,Λ₂,Λ₃) to the adversary (either Alice or Bob, depending upon the circumstances).

### 3.2.3 Delegatee Security

For each query to O_{rekey} on the input (pkᵢ,pkⱼ) (pkⱼ≠pk₀), the Challenger searches for the tuple (pkᵢ,pkⱼ,Λ₁,Λ₂,Λ₃) in table Tᵣₖ.

If this tuple, (pkᵢ,pkⱼ,Λ₁,Λ₂,Λ₃), does not exist, Bob chooses a random number rₚ ε Z_{q}* and sends (r,pkᵢ^{r},H₃(pkᵢ^{r}∥pkᵢ)^{x}^{ⱼ}) to the proxy (also the adversary). If pkᵢ=pk₀, Alice (the challenger in this case) will record (pk₀,pkⱼ,r,pkₒ^{r},H₃(pk₀^{r}∥pk₀)^{x}^{ⱼ}) into table Tᵣₖ.

Conversely, if this tuple, (pkᵢ,pkⱼ,Λ₁,Λ₂,Λ₃), does exist, the Challenger just returns (Λ₁,Λ₂,Λ₃) to the adversary.

### 3.2.4 Delegator Security

For each query to O_{rekey} on the input (pkᵢ,pkⱼ), the Challenger searches for the tuple (pkᵢ,pkⱼ,Λ₁,Λ₂,Λ₃) in table Tᵣₖ.

If this tuple does not exist, there are three cases:
1. If pkᵢ=pk₀, then Bob (the adversary) chooses a random number r ε Z_{q}*, and sends (r,pk₀^{r},H₃(pk₀^{r}∥pk₀)^{x}^{ⱼ}) to the proxy (also the adversary). At last, Alice (the challenger) will record (pk₀,pkⱼ,r,pk₀^{r},H₃(pk₀^{r}∥pk₀)^{x}^{ⱼ}) into table Tᵣₖ.
2. If pkᵢ≠pk₀ and pkⱼ≠pk₀, then the adversary can compute the rekeys by himself given the corresponding secret keys.
3. If pkᵢ≠pk₀ and pkⱼ=pk₀, then the Challenger Bob chooses a random number rₚ ε Z_{q}*, and sends (r,pkᵢ^{r},BLS.Sign(pk₀,(pkᵢ^{r}∥pkᵢ))) to the proxy.

Conversely, if this tuple, (pkᵢ,pkⱼ,Λ₁,Λ₂,Λ₃), does exist, the Challenger just returns (Λ₁,Λ₂,Λ₃) to the adversary.

Combining Theorem 1, Theorem 2 and the Lemma 1, Theorem 5 is constructed, as follows:

Theorem 5: In the random oracle model, the Sₘᵤ proxy re-signature process is correct and secure under the Computational Diffie-Hellman (CDH) assumption and the weaker Computational Diffie-Hellman (wCDH) assumption in G (External and Internal Security).

### 3.3 Reduction of Re-Signature Size

In various embodiments, to reduce the size of re-signature, the proxy re-signature system applies aggregate signature techniques for aggregating Dⱼ (1≦j≦i) into D=Πⱼ₌₁ⁱDⱼ. As a result, the verification equation of non-owner-type signatures changes to the construct illustrated by Equation 23, where:

$$e ( s , g ) {=}^{?} e ( {H}_{1} ( m ) , {A}_{1} ) , e ( {C}_{j} , {B}_{j} ) {=}^{?} e ( {H}_{2} ( s ) , {A}_{j} ) ( 1 \leq j \leq i ) , \\ e ( D , g ) {=}^{?} {\prod }_{j = 1}^{i - 1} e ( {H}_{3} ( {A}_{j} ‖ {B}_{j} ) , {A}_{j + 1} ) e ( {H}_{3} ( {A}_{i} ‖ {B}_{i} ) , p k ) . \qquad Equation 23$$

In order to maintain the multi-use property, the last Dⱼ (1≦j≦i), i.e. Dᵢ is stored as part of the signature, since in the scheme Sₘᵤ, the re-sign process changes Dⱼ into

$${D}_{i}^{{rk}_{A \to B}^{( 1 )}} .$$

The last Dⱼ can be verified by checking

$$e ( {D}_{i} , g ) {=}^{?} e ( {H}_{3} ( {A}_{i} ‖ {B}_{i} ) , p k ) .$$

The new aggregated D after re-signature, denoted as D^{′}, changes into

$$D \cdot {D}_{i}^{{rk}_{A \to B}^{( 1 )}} \cdot {rk}_{A \to B}^{( 3 )} / {D}_{i} .$$

### 3.4 Alternative More Efficient Version of the Proxy Re-Signature System Sₘᵤ^{′}

This alternative version of proxy re-signature process, denoted as Sₘᵤ′, is more efficient than the previous described proxy re-signature process Sₘᵤ. It includes four basic algorithms (since a signed message is assumed to be already available), including: KeyGen, ReKey, ReSign, and Verifywhere:
1. KeyGen: Given an input of a security parameter, 1^{k}, the KeyGen algorithm of the Sₘᵤ proxy re-signature process selects a random number a ε Z_{q}*, and outputs the key pair pk=g^{a} and sk=a. Note that this is the same as for the version Sₘᵤ described above.
2. Re-Signature Key Generation (ReKey): Given an input of Alice's public key and Bob's private key pk_{A} and sk_{B}=b, respectively, this ReKey algorithm outputs a re-signature key rk_{A→B}=(r,g^{r},H₃(g^{r}∥pk_{A})^{b}), where r is a random number in Z_{q}* determined by Bob only. The form of this re-signature key means that the signing rights of pk_{B} are delegated to pk_{A} with the help of g^{r}.
3. Re-Sign: Given the re-signature key, rk_{A→B}=(rk_{A→B}⁽¹⁾,rk_{A→B}⁽²⁾,rk_{A→B}⁽³⁾), described above, Alice's public key pk_{A}, and Alice's signature σ on message m, this ReSign algorithm first determines whether

$$Verify ( p {k}_{A} , m , σ ) {=}^{?} 1$$

is true (i.e., whether Alice's signature on message m is valid). If the verification check fails (i.e., Verify(pk_{A},m,σ)≠1, the ReSign algorithm outputs ⊥; otherwise, if the verification check is true (i.e., Verify(pk_{A},m,σ)=1), then:
a. if σ is an owner-type signature, σ=H₁(m)^{a}, the ReSign algorithm outputs a transformed signature, σ′, in the form of σ′=(s,A,B,C,D), where s=σ, A=rk_{A→B}⁽²⁾=g^{r}, B=pk_{A}=g^{a},

$$C = {{H}_{2} ( s )}^{{rk}_{A \to B}^{( 1 )}} = {{H}_{2} ( {{H}_{1} ( m )}^{a} )}^{r}$$

and D=rk_{A→B}⁽³⁾=H₃(g^{r}∥g^{a})^{b}.
b. if σ is a non-owner-type signature, σ=(s,A₁,B₁,C₁,D₁, . . . ,Aᵢ,Bᵢ,Cᵢ,Dᵢ), the ReSign algorithm outputs a transformed signature, σ′, in the form of σ′=(s,A₁,B₁,C₁,D₁, . . . ,Aᵢ,Bᵢ,Cᵢ,Dᵢ,rk_{A→B}⁽²⁾,pk_{A},

$${{H}_{2} ( s )}^{{rk}_{A \to B}} ,$$

rk_{A→B}⁽³⁾), where rk_{A→B}⁽²⁾=g^{r},

$${{H}_{2} ( s )}^{{rk}_{A \to B}^{( 1 )}} = {{H}_{2} ( s )}^{r} ,$$

and rk_{A→B}⁽³⁾=H₃(g^{r}∥pk_{A})^{b}).
4. Verify (Verify): Given the input of a public key, pk, a message m, and a corresponding signature σ, this Verify algorithm does the following:
   a. if σ is an owner-type signature, the Verify algorithm determines whether

$$e ( σ , g ) {=}^{?} e ( {H}_{1} ( m ) , p k ) .$$

If this equation is true, then the Verify algorithm outputs 1; otherwise, the Verify algorithm outputs 0.
c. if σ is a non-owner-type signature, then the Verify algorithm evaluates the following conditions, such that if each of the following conditions is true, the Verify algorithm outputs a “1” (i.e., verification successful). If any of the conditions is not true, the Verify algorithm outputs a “0” (i.e., verification failed).

$$e ( s , g ) {=}^{?} e ( {H}_{1} ( m ) , {B}_{1} ) , \\ e ( {C}_{j} , g ) {=}^{?} e ( {H}_{2} ( s ) , {A}_{j} ) ( 1 \leq j \leq i ) , \\ e ( {D}_{j} , g ) {=}^{?} e ( {H}_{3} ( {A}_{j} \vert \vert {B}_{j} ) , {B}_{j + 1} ) ( 1 \leq j < i ) , \\ e ( {D}_{i} , g ) {=}^{?} e ( {H}_{3} ( {A}_{i} \vert \vert {B}_{i} ) , p k ) .$$

The signature can be shortened by aggregating Dⱼ into D=Πⱼ₌₁ⁱDⱼ, and aggregating Cⱼ into C=Πⱼ₌₁ⁱCⱼ. The last Cⱼ and Dⱼ in this scheme do not need to be stored since re-signature does not change the last Cⱼ and Dⱼ in the old signature.

3.5 Standard Model Version of the Proxy Re-Signature System:

In various embodiments, the proxy re-signature system is further modified to convert the Sₘᵤ proxy re-signature process into an “Sₘᵤ*” proxy re-signature process that is proven secure in the proxy re-signature system security model without requiring the use of random oracles.

In general, the above-described Sₘᵤ proxy re-signature process is modified by replacing the BLS scheme with the Waters scheme, and replacing the mBLS process with the mWat process, respectively. Since both the Waters scheme and the mWat process are proven secure in the standard model, the Sₘᵤ* proxy re-signature process is also proven secure in the standard model.

In particular, the pubic parameters of the Sₘᵤ* proxy re-signature process are similar to those of the Waters scheme, except for the inclusion of three additional hash functions H₁:{0,1}*→{0,1}ⁿ^{ₘ}, H₂:{0,1}*→{0,1}ⁿ^{ₘ}, H₃:{0,1}*→{0,1}ⁿ^{ₘ}. Specifically, as with other proxy re-signature techniques, the Sₘᵤ* proxy re-signature process includes: KeyGen, ReKey, Sign, ReSign, and Verify algorithms, where:
1. Key Generation (KeyGen): Given the input of the security parameter 1^{k}, this KeyGen algorithm selects a random number a ε Z_{q}*. This KeyGen algorithm then outputs the key pair pk=g^{a} and sk=a.
2. Re-Signature Key Generation (ReKey): Given the input of Alice's public key pk_{A} and Bob's private key sk_{B}=b, this ReKey algorithm outputs the re-signature key rk_{A→B}=(r,pk_{A}^{r},g^{r},g₂^{b}H_{w}(pk_{A}^{r}∥pk_{A})^{r′},g^{r′}), where r is a random number in Z_{q}* determined by Bob. The re-signature key is generated by Bob and then delegates to the proxy to transform Alice's signature on a message to Bob's signature on the same message. Due to the security of the Waters scheme, one except Bob can generate a valid re-signature key.
   Note that the above described ReKey algorithm can also be described in terms of a unique modification to the Waters scheme as follows: given the input Alice's public key pk_{A} and Bob's private key sk_{B}=b, the ReKey algorithm outputs the re-signature key rk_{A→B}=(r,pk_{A}^{r},g^{r},Waters.Sign(b,pk_{A}^{r}∥pk_{A})).
3. Sign (Sign): Given the input of a secret key, sk=a, and a message m, this Sign algorithm outputs an owner-type signature σ=(g₂^{a}H_{w}(H₁(m))^{r},g^{r}), where r is a random number from Z_{q}*, or a non-owner-type signature σ=(s⁽¹⁾,s⁽²⁾,A₁,B₁,C₁,D₁⁽¹⁾,D₁⁽²⁾,D₁⁽³⁾,E₁⁽¹⁾,E₁⁽²⁾ . . . ,Aᵢ,Bᵢ,Cᵢ,Dᵢ⁽¹⁾,Dᵢ⁽²⁾,Dᵢ⁽³⁾,Eᵢ⁽¹⁾,Eᵢ⁽²⁾), where Aⱼ=g^{a}^{ⱼ}, Bⱼ=g^{b}^{ⱼ}, Cⱼ=g^{a}^{ⱼ}^{/b}^{ⱼ}, Dⱼ⁽¹⁾=g₂^{a}^{ⱼ}^{/b}^{ⱼ}H_{w}(s)^{r}^{ⱼ}, Dⱼ⁽²⁾=g^{r}^{ⱼ}, Dⱼ⁽³⁾=g^{a}^{ⱼ}^{r}^{ⱼ} for 1≦j≦i, Eⱼ⁽¹⁾=g₂^{a}^{ⱼ₊₁}H_{w}(gⱼ^{a}∥gⱼ^{b})^{r′}^{ⱼ}, and Eⱼ⁽²⁾=g^{r′}^{ⱼ} for 1≦j<i, and Eᵢ⁽¹⁾=g₂^{a}H_{w}(gᵢ^{a}∥gᵢ^{b})^{r}^{ᵢ}, Eᵢ⁽¹⁾=g^{r}^{ᵢ} and aⱼ, bⱼ, rⱼ, and rⱼ (1≦j≦i) are random numbers in Z_{q}*, s₁⁽¹⁾=g₂^{a}H_{w}(m)^{r} and s₂⁽¹⁾=g^{r}. Note that this Sign algorithm can also be described in terms of a unique modification to the Waters scheme in combination with the mWat process as follows:

(Dⱼ⁽¹⁾,Dⱼ⁽²⁾,Dⱼ⁽³⁾)=mWat.Sign(aⱼ/bⱼ,s)(1≦j≦i),

(Eⱼ⁽¹⁾,Eⱼ⁽²⁾)=Waters.Sign(a₂,g^{a}^{₁}∥g^{b}^{₁})(1≦j<i),

(Eᵢ⁽¹⁾,Eᵢ⁽²⁾)=Waters.Sign(a,g^{a}^{ᵢ}∥g^{b}^{ᵢ}).
4. Re-Sign (ReSign): Given a re-signature key, rk_{A→B}=(rk_{A→B}⁽¹⁾,rk_{A→B}⁽²⁾,rk_{A→B}⁽³⁾,rk_{A→B}⁽⁴⁾,rk_{A→B}⁽⁵⁾), a public key pk_{A}, a signature σ, and a message m, this ReSign algorithm first determines whether

$$Verify ( p {k}_{A} , m , σ ) {=}^{?} 1$$

is true. If the verification fails (i.e., Verify(pk_{A},m,σ)≠1), then the ReSign algorithm outputs ⊥; otherwise, if the verification succeeds (i.e., Verify(pk_{A},m,σ)=1), then the ReSign algorithm performs the following:
a. if σ is an owner-type signature, σ=(g₂^{a}H_{w}(H₁(m))^{r′},g^{r′}), then the ReSign algorithm outputs a transformed signature, σ′, in the form of σ′=(s⁽¹⁾,s⁽²⁾,A,B,C,D⁽¹⁾,D⁽²⁾,D⁽³⁾,E⁽¹⁾,E⁽²⁾), where:

$${s}^{( 1 )} = {( {g}_{2}^{a} {{H}_{w} ( {H}_{1} ( m ) )}^{{r}^{′}} )}^{{rk}_{A \to B}^{( 1 )}} , \\ {s}^{( 2 )} = {( {g}^{{r}^{′}} )}^{{rk}_{A \to B}^{( 1 )}} , A = {rk}_{A \to B}^{( 2 )} , \\ B = p {k}_{A} = {g}^{a} , C = {rk}_{A \to B}^{( 3 )} , \\ {D}^{( 1 )} = {g}_{2}^{{rk}_{A \to B}^{( 1 )}} {{H}_{w} ( {H}_{2} ( {s}^{( 1 )} \vert \vert {s}^{( 2 )} ) )}^{{r}^{″}} , {D}^{( 2 )} = {g}^{{r}^{″}} , \\ {D}^{( 3 )} = {( {g}^{a} )}^{{r}^{″}} , {E}^{( 1 )} = {rk}_{A \to B}^{( 4 )} , {E}^{( 2 )} = {rk}_{A \to B}^{( 5 )} .$$

b. if σ is a non-owner-type signature, σ=(s⁽¹⁾,s⁽²⁾,A₁,B₁,C₁,D₁⁽¹⁾,D₁⁽²⁾,D₁⁽³⁾,E₁⁽¹⁾,E₁⁽²⁾, . . . ,Aᵢ,Bᵢ,Cᵢ,Dᵢ⁽¹⁾,Dᵢ⁽²⁾,Dᵢ⁽³⁾,Eᵢ⁽¹⁾,Eᵢ⁽²⁾), then the ReSign algorithm outputs a transformed signature, σ′, in the form of:

$${σ}^{′} = ( {s}^{( 1 )} , {s}^{( 2 )} , {A}_{1} , {B}_{1} , {C}_{1} , {D}_{1}^{( 1 )} , {D}_{1}^{( 2 )} , {D}_{1}^{( 3 )} , {E}_{1}^{( 1 )} , {E}_{1}^{( 2 )} … , {A}_{i} , {B}_{i} , {C}_{i} , {D}_{i}^{( 1 )} , {D}_{i}^{( 2 )} , {D}_{i}^{( 3 )} , {( {E}_{i}^{( 1 )} )}^{{rk}_{A \to B}^{( 1 )}} , {( {E}_{i}^{( 2 )} )}^{{rk}_{A \to B}^{( 1 )}} , {rk}_{A \to B}^{( 2 )} , p {k}_{A} , {rk}_{A \to B}^{( 3 )} , {g}_{2}^{{rk}_{A \to B}^{( 1 )}} , {g}_{2}^{{rk}_{A \to B}^{( 1 )}} {{H}_{w} ( {H}_{2} ( {s}^{( 1 )} \vert \vert {s}^{( 2 )} ) )}^{{r}^{″}} , {g}^{{r}^{″}} , p {k}_{A}^{{r}^{″}} , {rk}_{A \to B}^{( 4 )} , {rk}_{A \to B}^{( 5 )} ) , \\ where \text{:}$$

$${( {E}_{i}^{( 1 )} )}^{{rk}_{A \to B}^{( 1 )}} = {( {g}_{2}^{a} {{H}_{w} ( {H}_{3} ( {g}^{{a}_{i}} \vert \vert {g}^{{b}_{i}} ) )}^{{r}^{′}} )}^{{rk}_{A \to B}^{( 1 )}}$$

$${( {E}_{i}^{( 2 )} )}^{{rk}_{A \to B}^{( 1 )}} = ( {g}^{{r}^{′}} ) {rk}_{A -> B}^{( 1 )} .$$

Note that the above-described ReSign algorithm can be described in terms of a unique modification to the Waters scheme and the mWat process as follows:
a. if σ is an owner-type signature, then:

(D₁⁽¹⁾,D₁⁽²⁾,D₁⁽³⁾)←mWat.Sign(r,H₂(s⁽¹⁾∥s⁽²⁾)),

(E₁⁽¹⁾,E₁⁽²⁾)←Waters.Sign(b,H₃(pk_{A}^{r}∥pk_{A})).
b. if σ is a non-owner-type signature, then:

(g₂^{rk}^{_{A→B}}^{⁽¹⁾}H_{w}(H₂(s⁽¹⁾∥s⁽²⁾))^{r′},g^{r′},pk_{A}^{r′})←mWat.Sign(r,H₂(s⁽¹⁾∥s⁽²⁾,

(rk_{A→B}⁽⁴⁾,rk_{A→B}⁽⁵⁾)←Waters.Sign(b,H₃(pk_{A}^{r}∥pk_{A})).
5. Verify (Verify): Given the input of a public key, pk, a message m, and a signature σ, this Verify algorithm performs the following:
   a. if σ is an owner-type signature (σ₁,σ₂), this Verify algorithm determines whether

$$e ( {σ}_{1} , g ) {=}^{?} e ( {H}_{w} ( {H}_{1} ( m ) ) , {σ}_{2} ) e ( {g}_{2} , p k )$$

is true. If this condition is true, then the Verify algorithm outputs “1”; otherwise, the Verify algorithm outputs “0”.
b. if σ is a non-owner-type signature, σ=(s⁽¹⁾,s⁽²⁾,A₁,B₁,C₁,D₁⁽¹⁾,D₁⁽²⁾,D₁⁽³⁾,E₁⁽¹⁾,E₁⁽²⁾ . . . ,Aᵢ,Bᵢ,Cᵢ,Dᵢ⁽¹⁾,Dᵢ⁽²⁾,Dᵢ⁽³⁾,Eᵢ⁽¹⁾,Eᵢ⁽²⁾), this Verify algorithm determines whether the following conditions are true, and if each of the following conditions are true, then the Verify algorithm outputs “1”; otherwise, the Verify algorithm outputs “0”.

$$for 1 \leq j \leq i \text{:}$$

$$e ( {s}^{( 1 )} , g ) {=}^{?} e ( {H}_{w} ( {H}_{1} ( m ) ) , {s}^{( 2 )} ) e ( {g}_{2} , {A}_{1} ) , \\ e ( {D}_{j}^{( 1 )} , g ) = e ( {H}_{w} ( {H}_{2} ( {s}^{( 1 )} \vert \vert {s}^{( 2 )} ) ) , {D}_{j}^{( 2 )} ) e ( {g}_{2} , {C}_{j} ) , \\ e ( {C}_{j} , {B}_{j} ) = e ( {A}_{j} , g ) , e ( {B}_{j} , {D}_{j}^{( 2 )} ) = e ( {D}_{j}^{( 3 )} , g ) , \\ for 1 \leq j < i$$

$$e ( {E}_{j}^{( 1 )} , g ) = e ( {H}_{w} ( {H}_{3} ( {A}_{j} \vert \vert {B}_{j} ) ) , {E}_{j}^{( 2 )} ) e ( {g}_{2} , {B}_{j + 1} ) , \\ e ( {E}_{i}^{( 1 )} , g ) = e ( {H}_{w} ( {H}_{3} ( {A}_{i} \vert \vert {B}_{i} ) ) , {E}_{i}^{( 2 )} ) e ( {g}_{2} , p k ) .$$

Note that the above-described Verify algorithm can be described in terms of a unique modification to the Waters scheme and the mWat process as follows, where, in either case, if the outputs of all verifications are true, the Verify algorithm outputs “1”; otherwise, the Verify algorithm outputs “0”, where:
1. if σ is an owner-type signature, (σ₁,σ₂), then:

Waters.Ver(σ,pk,H,₁(m))
2. if σ is a non-owner-type signature, σ=(s⁽¹⁾,s⁽²⁾,A₁,B₁,C₁,D₁⁽¹⁾,D₁⁽²⁾,D₁⁽³⁾,E₁⁽¹⁾,E₁⁽²⁾ . . . ,Aᵢ,Bᵢ,Cᵢ,Dᵢ⁽¹⁾,Dᵢ⁽²⁾,Dᵢ⁽³⁾,Eᵢ⁽¹⁾,Eᵢ⁽²⁾), then:

Waters.Ver((s⁽¹⁾,s⁽²⁾),A₁,H₁(m)), where:
for 1≦j≦i:

mWat.Ver((Dⱼ⁽¹⁾,Dⱼ⁽²⁾,Dⱼ⁽³⁾),(Aⱼ,Bⱼ,Cⱼ),H₂(s⁽¹⁾∥s⁽²⁾)),

e(Cⱼ,Bⱼ)=e(Aⱼ,g),e(Bⱼ,Dⱼ⁽²⁾)=e(Dⱼ⁽³⁾,g),
for 1≦j<i:

Waters.Ver((Eⱼ⁽¹⁾,Eⱼ⁽²⁾),Aⱼ₊₁,H₃(Aⱼ∥Bⱼ),

Waters.Ver((Eᵢ⁽¹⁾,Eᵢ⁽²⁾),pk,H₃(Aᵢ∥Bᵢ)).

### 3.5.1 Security Considerations

The following paragraphs discuss security considerations of the Sₘᵤ* proxy re-signature process without the use of random oracles.

Lemma 2: In the standard model, the Sₘᵤ* proxy re-signature process is correct and secure if both the Waters scheme and the mWat scheme are secure under adaptive chosen-message attacks.

Proof Summary: As discussed above, in order to construct the Sₘᵤ* proxy re-signature process from a starting point of the Sₘᵤ proxy re-signature process, the BLS scheme and the mBLS process of the Sₘᵤ proxy re-signature process were replaced with the Waters scheme and the mWat process, respectively. Therefore, the proof of Lemma 1 can be used to prove the security of the Sₘᵤ* proxy re-signature process by changing BLS and mBLS to Waters and mWat, respectively.

Then, combining Theorem 3, Theorem 4 and Lemma 2, Theorem 6 is constructed, as follows:

Theorem 6: In the standard model, the Sₘᵤ* proxy re-signature process is correct and secure under the Computational Diffie-Hellman (CDH) assumption and the Extended Computational Diffie-Hellman (ECDH) assumption in G (External and Internal Security).

### 4.0 Operational Summary of the Proxy Re-Signature System

In view of the preceding discussion, it should be clear that there are three basic forms of the proxy re-signature system, with numerous additional embodiments associated with each of those forms. In particular, as described in Section 3.1, one of the three basic forms of the proxy re-signature system provides various non-interactive message re-signature techniques under a random oracle model. As described in Section 3.4, the second basic form of the proxy re-signature system provides various alternative non-interactive message re-signature techniques under a random oracle model. Finally, as described in Section 3.5, the third basic form of the proxy re-signature system provides various non-interactive message re-signature techniques under the standard model (i.e., no random oracles.

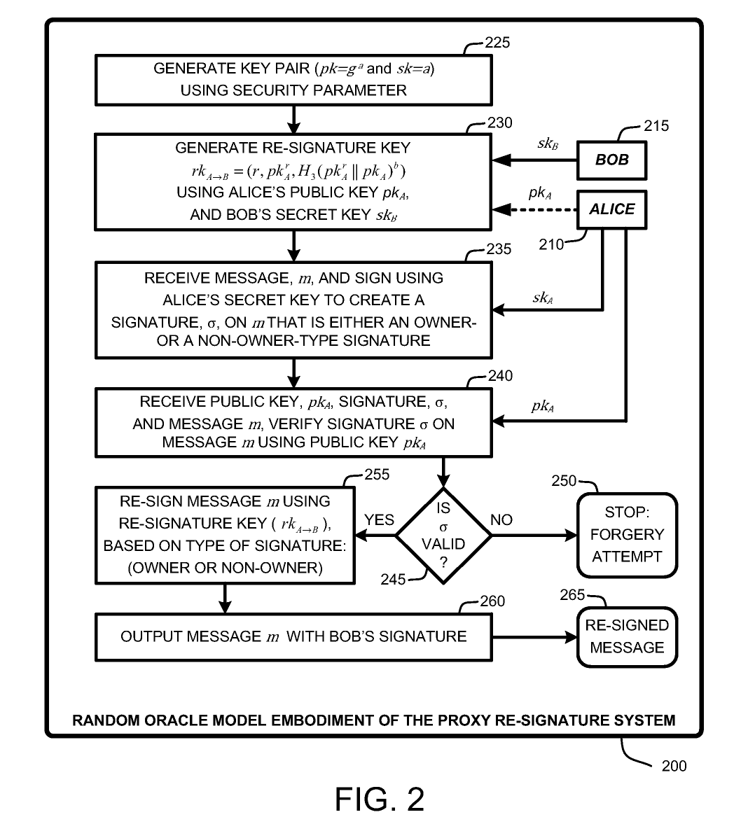

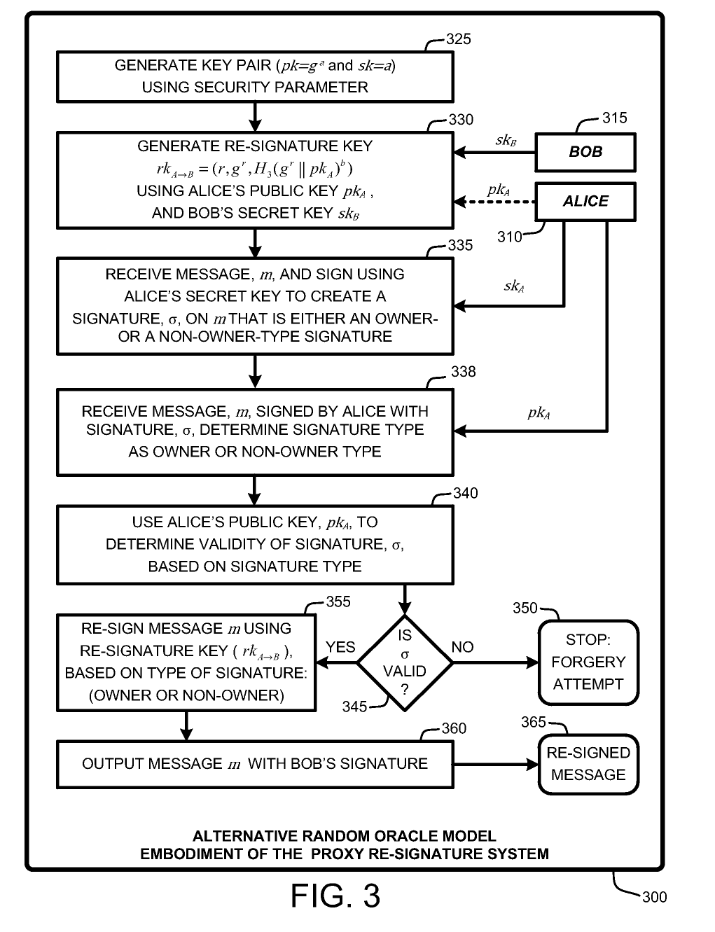

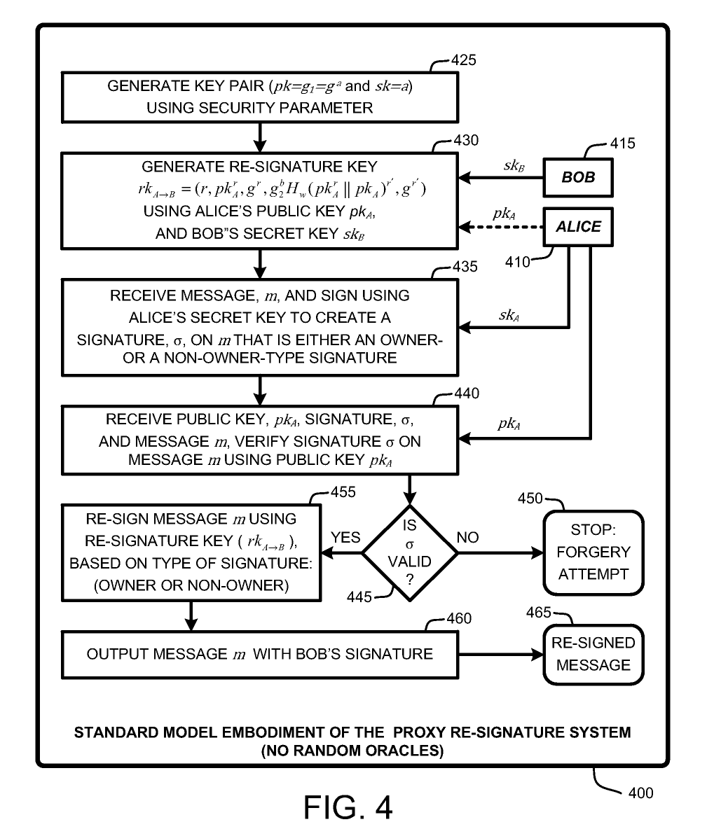

The processes described above with respect to FIG. 1, and in further view of the detailed description provided above in Sections 1 through 3 are illustrated by the general operational flow diagrams of FIG. 2, FIG. 3, and FIG. 4, which illustrate various embodiments of each of the three basic forms of the proxy re-signature systems. Note that FIG. 2, FIG. 3, and FIG. 4 are not intended to be exhaustive representations of all of the various embodiments of the proxy re-signature system described herein, and that the embodiments represented in FIG. 2, FIG. 3, and FIG. 4 are provided only for purposes of explanation.

Further, it should be noted that any boxes and interconnections between boxes that may be represented by broken or dashed lines in FIG. 2, FIG. 3, and FIG. 4 represent optional or alternate embodiments of the proxy re-signature system described herein, and that any or all of these optional or alternate embodiments, as described below, may be used in combination with other alternate embodiments that are described throughout this document.

### 4.1 Non-Interactive Random Oracle Embodiment

In general, as illustrated by FIG. 2, the non-interactive random oracle model embodiment of the proxy re-signature system 200 begins with an key pair generation module 225, and includes a non-interactive re-signature key generation module 230 in which a delegator Bob 215 generates the re-signature key for the purpose to transform Alice's signature on a message to Bob's signature on that same message. Note that FIG. 2 shows the modules in the proxy re-signature system 200 rather than the actual relationship of those modules. Note also that as described in Section 3.1, the non-interactive random oracle model embodiment of the proxy re-signature system 200 is also referred to as the Sₘᵤ proxy re-signature process.

In particular, as described above in Section 3.1, in the Sₘᵤ proxy re-signature process, the key pair generation module 225 receives an input of a security parameter, 1^{k}. The KeyGen algorithm of the Sₘᵤ proxy re-signature process then uses the security parameter, 1^{k} to select a random number a ε Z_{q}*, and generate 225 the key pair pk=g^{a} and sk=a.

Next, re-signature key generator 230 produces a re-signature key to be used by the re-signing module 255 to transform delegate Alice's 210 signature to delegator Bob's 215 signature. In general, as described in detail in Section 3.1, given an input of Alice's public key pk_{A}=g^{a} and Bob's private key sk_{B}=b, the ReKey algorithm of the Sₘᵤ proxy re-signature key generating process 230 generates the re-signature key rk_{A→B}=(r,pk_{A}^{r},H₃(pk_{A}^{r}∥pk_{A})^{b}), where r is a random number in Z_{q}* determined by Bob. Note that the re-signature key is generated by delegator Bob alone, and the resulting key is sent to the proxy through a secure channel so that the proxy can use it to transform Alice's signature on a message to Bob's signature on that same message. Delegatee Alice or the proxy is not involved in generating the re-signature key. Alice's public key can be obtained through various chennels. Therefore the re-signature key generation is non-interactive.

Next, a signer such as the delegate Alice 210 in this example receives a message, m, that has not been signed previously, uses her secret key and then signs 235 that message using one of two possible types of signatures. In particular, the signing 235 of the message is accomplished using either an owner-type signature, σ=H₁(m)^{a}, or a non-owner-type signature σ=(s,A₁,B₁,C₁,D₁, . . . ,Aᵢ,Bᵢ,Cᵢ,Dᵢ), where Aⱼ=g^{a}^{ⱼ}, Bⱼ=g^{b}^{ⱼ}, and Cⱼ=H₂(s)^{a}^{ⱼ}^{/b}^{ⱼ} for 1≦j≦i, and Dⱼ=H₃(gⱼ^{a}∥gⱼ^{b})^{a}^{ⱼ₊₁}, for 1≦j<i, and Dᵢ=H₃(gᵢ^{a}∥gᵢ^{b})^{a}, and aⱼ and bⱼ (1≦i) are random numbers in Z_{q}* and s=H₁(m)^{a}^{₁}.

Once the message has been signed by 235, a verifier receives Alice's 210 public key, pk_{A}, and attempts to verify 240 if the signature, σ, on the signed message m, is valid (i.e., that the message was actually signed by Alice). As discussed in detail in Section 3.1, this verification process 240 evaluates different conditions to determine validity of the signature depending upon whether the signature type on the message is an owner-type signature, or a non-owner-type signature.

For a message signed by Alice 210 to be transformed into Bob's 215 signature on that same message, a verifier is first used to check if the received signed message is actually signed by Alice. If the signature is determined 245 to be invalid (i.e., any of the validity conditions described in Section 3.1 are not satisfied), then the proxy terminates 250 the signature transformation process due to a suspected forgery attempt.

On the other hand, assuming that the signature is determined 245 to be valid (i.e., all of the validity conditions described in Section 3.1 for the particular signature type are satisfied), then the proxy re-signs 255 the message using the previously generated 230 re-signature key, rk_{A→B}=(r,pk_{A}^{r},H₃(pk_{A}^{r}∥pk_{A})^{b}). As discussed in detail in Section 3.1, this re-signature process 255 uses different transformation processes depending upon whether the signature type on the message is an owner-type signature, or a non-owner-type signature. Finally, the proxy outputs 260 message m with Bob's 215 signature as a re-signed message 265.

### 4.2 Alternative Non-Interactive Random Oracle Embodiment

In general, as illustrated by FIG. 3, the non-interactive random oracle model embodiment of the proxy re-signature system 300 begins an key pair generator 325, and includes a non-interactive re-signature key generator 330 to generate a re-signature key to transform Alice's 310 signature on a message to Bob's 315 signature on that same message. Note that FIG. 2 shows the modules in the proxy re-signature system 300 rather than the actual relationship of those modules. Note that as described in Section 3.4, the non-interactive random oracle model embodiment of the proxy re-signature system 300 is also referred to as the alternative non-interactive proxy re-signature process, denoted as Sₘᵤ^{′}.

In particular, as described above in Section 3.4, in the alternative non-interactive proxy re-signature process Sₘᵤ^{′}, the key pair generator 325 receives an input of a security parameter, 1^{k}. The KeyGen algorithm of the alternative non-interactive proxy re-signature system Sₘᵤ^{′} then uses the security parameter, 1^{k} to select a random number a ε Z_{q}*, and generate 325 the key pair pk=g^{a} and sk=a. Note that this is the same process as described in Section 4.1 with respect to element 225 in FIG. 2.

Next, the delegator Bob 315 generates 330 a re-signature key which is then delegated to the proxy to transform the delegatee's signature on a message to delegator's signatures on that same message. Note also that once generated, the re-signature key can be reused to transform many signatures. In general, as described in detail in Section 3.4, given an input of Bob's private key, sk_{B}=b, and Alice's public key, pk_{A}, the ReKey algorithm of the alternative non-interactive proxy re-signature system Sₘᵤ^{′} generates 330 the re-signature key rk_{A→B}=(r,g^{r},H₃(g^{r}∥pk_{A})^{b}), where r is a random number in Z_{q}* determined by Bob only. Note that the re-signature key generation is done in this embodiment by Bob alone and the resulting re-signature key is sent to the proxy through a secure channel. Therefore the re-signature key generation itself is non-interactive since Alice and the proxy are not involved in the process of the re-signature key generation.

Next, a signer such as the delegate Alice 310 in this example receives a message, m, that has not been signed previously, uses her secret key and then signs 335 that message using one of two possible types of signatures. This process is the same as 225 in FIG. 2.

Next, a verifier received a message, m, previously signed by Alice 310 with signature σ. The verifier then evaluates the signature type to determine 338 whether the signature is an owner-type signature, or a non-owner-type signature. As with the non-interactive proxy re-signature process Sₘᵤ, in the case of an owner-type signature, the signature will take the form of σ=H₁(m)^{a}. Similarly, as with the non-interactive proxy re-signature process Sₘᵤ, a non-owner-type signature will take the form of σ=(s,A₁,B₁,C₁,D₁, . . . ,Aᵢ,Bᵢ,Cᵢ,Dᵢ).

Having determined 338 the signature type, the verifier then attempts to determine the validity 340 the signature, σ, on the signed message m, using Alice's 310 public key, pk_{A}. As discussed in detail in Section 3.4, this verification process 340 evaluates different conditions to determine validity of the signature depending upon whether the signature type on the message is an owner-type signature, or a non-owner-type signature.

The same signature verification process is applied by the re-signature proxy in transforming Alice's signature on a message to Bob's signature on that same message. Upon receiving a message signed by Alice, the proxy applies the verification process to check validity of the received signed message. If the signature is determined 345 to be invalid (i.e., any of the validity conditions described in Section 3.4 are not satisfied for the particular signature type), then the proxy terminates 350 the signature transformation process due to a suspected forgery attempt.

On the other hand, assuming that the signature is determined 345 to be valid (i.e., all of the validity conditions described in Section 3.4 for the particular signature type are satisfied), then the proxy re-signs 355 the message using the previously generated 330 re-signature key, rk_{A→B}=(r,g^{r},H₃(g^{r}∥pk_{A})^{b}). As discussed in detail in Section 3.4, this re-signature process 355 uses different transformation processes depending upon whether the signature type on the message is an owner-type signature, or a non-owner-type signature. Finally, the proxy outputs 360 message m with Bob's 315 signature as a re-signed message 365.

### 4.3 Non-Interactive Standard Model Embodiment

In general, as illustrated by FIG. 4, the non-interactive standard model embodiment (no random oracles) of the proxy re-signature system 400 begins with an key pair generation module 425, and includes an non-interactive re-signature key generation module 430 in which Bob 415 uses his private key and Alice's 410 public key to generate a re-signature key and delegates the resulting key to the proxy for the purpose to transform Alice's signature on a message to Bob's signature on that same message. Note that FIG. 2 shows the modules in the proxy re-signature system 400 rather than the actual relationship of those modules. Note that as described in Section 3.5, the non-interactive random oracle model embodiment of the proxy re-signature system 400 is also referred to as the Sₘᵤ* proxy re-signature process.

In particular, as described above in Section 3.5, with respect to the non-interactive Sₘᵤ* proxy re-signature system, the key pair generator 425 receives an input of a security parameter, 1^{k}. The KeyGen algorithm of the Sₘᵤ* proxy re-signature system then uses the security parameter, 1^{k} to select a random number a ε Z_{q}*, for use in generating 425 the key pair pk=g^{a} and sk=a.

Next, the re-signature key generator 430 produces a re-signature key to be used by the re-signing module 455 to transform delegate Alice's 410 signature to delegator Bob's 415 signature. In general, as described in detail in Section 3.5, given an input of Alice's public key pk_{A} and Bob's private key sk_{B}=b, the ReKey algorithm of the Sₘᵤ* proxy re-signature process generates 430 the re-signature key rk_{A→B}=(r,pk_{A}^{r},g^{r},g₂^{b}H_{w}(pk_{A}^{r}∥pk_{A})^{r′},g^{r′}), where r is a random number in Z_{q}* determined by Bob. Note that the re-signature key is generated by Bob alone and the resulting key is delegated to the proxy.

Next, a signer such as the delegate Alice 410 in this example receives a message, m, and uses her secret key to sign 435 that message using one of two possible types of signatures. In particular, the signing 435 of the message is accomplished using either an owner-type signature, σ=(g₂^{a}H_{w}(H₁(m))^{r},g^{r}), where r is a random number from Z_{q}*, or a non-owner-type signature in the form of: σ=(s⁽¹⁾,s⁽²⁾,A₁,B₁,C₁,D₁⁽¹⁾,D₁⁽²⁾,D₁⁽³⁾,E₁⁽¹⁾,E₁⁽²⁾ . . . ,Aᵢ,Bᵢ,Cᵢ,Dᵢ⁽¹⁾,Dᵢ⁽²⁾,Dᵢ⁽³⁾,Eᵢ⁽¹⁾,Eᵢ⁽²⁾), where Aⱼ=g^{a}^{ⱼ}, Bⱼ=g^{b}^{ⱼ}, Cⱼ=g^{a}^{ⱼ}^{/b}^{ⱼ}, Dⱼ⁽¹⁾=g₂^{a}^{ⱼ}^{/b}^{ⱼ}H_{w}(s)^{r}^{ⱼ}, Dⱼ⁽²⁾=g^{r}^{ⱼ}, Dⱼ⁽³⁾=g^{a}^{ⱼ}^{r}^{ⱼ} for 1≦j≦i, Eⱼ⁽¹⁾=g₂^{a}^{ⱼ₊₁}H_{w}(gⱼ^{a}∥gⱼ^{b})^{r′}^{ⱼ}, and Eⱼ⁽²⁾=g^{r′}^{ⱼ} for 1≦j<i, and Eᵢ⁽¹⁾=g₂^{a}H_{w}(gᵢ^{a}∥gᵢ^{b})^{r}^{ᵢ}, Eᵢ⁽¹⁾=g^{r}^{ᵢ} and aⱼ, bⱼ, rⱼ, and rⱼ (1≦j≦i) are random numbers in Z_{q}*, s₁⁽¹⁾=g₂^{a}H_{w}(m)^{r} and s₂⁽¹⁾=g^{r}.

Once the message has been signed by 435, a verifier receives Alice's 410 public key, pk_{A}, and attempts to verify 440 the signature, σ, on the signed message m, is valid (i.e., that the message was actually signed by Alice). As discussed in detail in Section 3.5, this verification process 440 evaluates different conditions to determine validity of the signature depending upon whether the signature type on the message is an owner-type signature, or a non-owner-type signature.

For a message signed by Alice 410 to be transformed into Bob's 415 signature on that same message, a verifier is first used to check if the received signed message is actually signed by Alice. If the signature is determined 445 to be invalid (i.e., any of the validity conditions described in Section 3.5 are not satisfied), then the proxy terminates 450 the signature transformation process due to a suspected forgery attempt.

On the other hand, assuming that the signature is determined 445 to be valid (i.e., all of the validity conditions described in Section 3.5 for the particular signature type are satisfied), then the proxy re-signs 455 the message using the previously generated 430 re-signature key, rk_{A→B}=(r,pk_{A}^{r},g^{r},g₂^{b}H_{w}(pk_{A}^{r}∥pk_{A})^{r′},g^{r′}). As discussed in detail in Section 3.5, this re-signature process 455 uses different transformation processes depending upon whether the signature type on the message is an owner-type signature, or a non-owner-type signature. Finally, the proxy outputs 460 message m with Bob's 415 signature as a re-signed message 465.

### 5.0 Exemplary Operating Environments

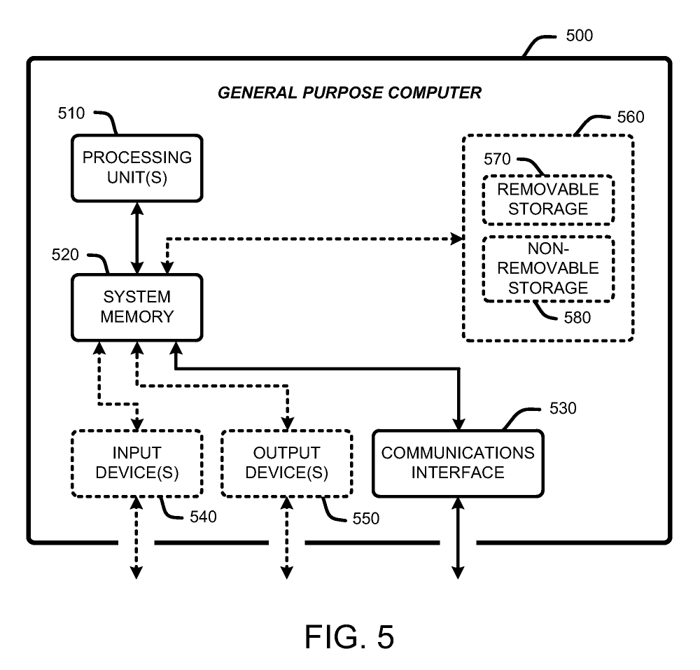

The proxy re-signature system is operational within numerous types of general purpose or special purpose computing system environments or configurations. FIG. 5 illustrates a simplified example of a general-purpose computer system on which various embodiments and elements of the proxy re-signature system, as described herein, may be implemented. It should be noted that any boxes that are represented by broken or dashed lines in FIG. 5 represent alternate embodiments of the simplified computing device, and that any or all of these alternate embodiments, as described below, may be used in combination with other alternate embodiments that are described throughout this document.

For example, FIG. 5 shows a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

At a minimum, to allow a device to implement the proxy re-signature system, the device must have some minimum computational capability along with a communications interface for interacting with other delegatees or delegators. In particular, as illustrated by FIG. 5, the computational capability is generally illustrated by one or more processing unit(s) 510, and may also include one or more GPUs 515. Note that that the processing unit(s) 510 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 5 may also include other components, such as, for example, a communications interface 530. The simplified computing device of FIG. 5 may also include one or more conventional computer input devices 540. The simplified computing device of FIG. 5 may also include other optional components, such as, for example one or more conventional computer output devices 550. Finally, the simplified computing device of FIG. 5 may also include storage 560 that is either removable 570 and/or non-removable 580. Note that typical communications interfaces 530, input devices 540, output devices 550, and storage devices 560 for general-purpose computers are well known to those skilled in the art, and will not be described in detail herein.

The foregoing description of the proxy re-signature system has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the proxy re-signature system. It is intended that the scope of the invention be limited not by this detailed description, but rather by the claims appended hereto.

What is claimed is:

1. A method for using a proxy to transform a signature of a delegatee to a signature of a delegator on a message, comprising steps for:
generating a public and private key pair for the delegatee;
signing a message with the delegates's signature, and verifying authenticity of the signed message using the key pair;
generating a re-signature key for the delegator;
delegating the re-signature key to a proxy; and
causing the proxy to transform a signature of the delegatee on the message to the signature of the delegator on the message by processing the signature of the delegatee using the re-signature key.

2. The method of claim 1 wherein generating the public and private key pair further comprises steps for using a discrete logarithm-based key generation algorithm to generate the pair of public and private keys.

3. The method of claim 1 wherein signing the message further comprises steps for signing the message by using a chain of signatures from a BLS signing process and an mBLS signing process.

4. The method of claim 1 wherein signing the message further comprises steps for signing the message by using a chain of signatures from a Waters signing process and an mWaters signing process.

5. The method of claim 1 wherein generating the re-signature key further comprises steps for using the delegator's private key in combination with the delegatee's public key to generate the re-signature key.

6. The method of claim 5 wherein the re-signature key is generated with one of a BLS-based signature process and a Waters-based signature process.

7. The method of claim 1 further comprising steps for reducing a size of the transformed signature by using a signature aggregation process.

8. The method of claim 1 wherein the key pair is temporary, such that the resulting re-signature key is also temporary and will expire after a predetermined period of time.

9. The method of claim 1 further comprising steps for determining validity of the signature of the delegator on the message.

10. The method of claim 9 the determining validity of the signature of the delegator on the message further comprises steps for verifying an entire chain of signatures, and wherein the chain of signature is one of:
a chain of signatures generated by a BLS signature process and a mBLS signature process; and
a chain of signatures generated by a Waters signature process and an mWaters signature process.

11. The method of claim 9 further comprising steps for terminating transformation of the signature of the delegator if the signature of the delegator on the message is determined to be invalid.

12. The method of claim 1 wherein the signature of the delegator on the message is of a signature type including one of an owner-type signature and a non-owner-type signature.

13. A system for transforming a signature of a delegatee to a signature of a delegator on a message, comprising:
a device for generating a public and private key pair for the delegatee;
a device for allowing a delegatee to sign a message;
a device for verifying authenticity of a signature of the delegatee on the signed message using the key pair;
a device for generating a re-signature key for the delegator using a combination of a private key of the delegator and the public key of the delegatee;
a device for delegating the re-signature key to a proxy; and
a device for transforming the signature of the delegatee on the message to the signature of the delegator on the message by using a proxy to process the signature of the delegatee using the re-signature key.

14. The system of claim 13 wherein generating the re-signature key further comprises allowing the delegator to use the delegator's private key in combination with the delegatee's public key to generate the re-signature key.

15. The system of claim 13 further comprising a device for terminating the transformation in the event that the signature of the delegatee on the signed message is not authentic.

16. The system of claim 13 further comprising a device for terminating the transformation in the event that the transformed signature of the delegator on the signed message is not authentic.

17. A computer-readable medium having computer executable instructions stored therein for using a proxy to transform a signature of a delegatee to a signature of a delegator on a message, said instructions comprising:
using a signer module for generating a public and private key pair for the delegatee;
providing a message with the delegates's signature;
using a proxy for generating a re-signature key for the delegator from a combination of a private key of the delegator and the public key of the delegatee;
delegating the re-signature key to a proxy; and
causing the proxy to transform a signature of the delegatee on the message to the signature of the delegator on the message by processing the signature of the delegatee using the re-signature key.

18. The computer-readable medium of claim 17 further using a signature verification module for verifying authenticity of the signature of the delegatee on signed message using the key pair.

19. The computer-readable medium of claim 18 further comprising terminating transformation of the signature if the signature of the delegatee is not authentic.

20. The computer-readable medium of claim 17 wherein the re-signature key is generated with one of a BLS-based signature process and a Waters-based signature process.
